(19) United States
(12) Patent Application Publication
(10) Pub. No.: US 2013/0179315 A1
(43) Pub. Date: Jul. 11, 2013

(54) Time and Attendance System and Method

(71) Applicants: Edward Feliciano Lopez, Carolina, PR (US); Darwin Oscar Quinones Pimentel, Carolina, PR (US)

(72) Inventors: Edward Feliciano Lopez, Carolina, PR (US); Darwin Oscar Quinones Pimentel, Carolina, PR (US)

(21) Appl. No.: 13/357,614

(22) Filed: Jan. 25, 2012

Related U.S. Application Data
(60) Provisional application No. 61/584,813, filed on Jan. 9, 2012.

(51) Int. Cl. G06Q 30/04; G06Q 40/00

(52) U.S. Cl. 705/32

(57) ABSTRACT

The system and method of this invention enables the tracking of time and attendance of employees and personnel and the assignment of a salary or pay rate based on the position or job of the employee. An person's salary rate may automatically change according to the job type, place of work, or the period of time in which the person is working. The system generates time cards, which may be used by an invoicing means to produce invoices automatically.

### STATEMENT REGARDING FEDERALLY SPONSORED RESEARCH AND DEVELOPMENT

N/A

### RELATED APPLICATIONS

N/A

### BACKGROUND

Currently, many small and large businesses, and particularly employment agencies, use paper time cards or slips to keep track of workers and employees attendance to work. Certain businesses, such as hotels, museums, convention centers, and resorts, have fluctuating demands and benefit from contracting temporary employment agencies. Because the workers are employees of the employment agency, there is a need for a time attendance system and method that is able to manage the distribution of agency employees through various departments and positions of multiple businesses that contract the services of the employment agency while keeping the correct salary for every worker. Furthermore, there is a need for a system and a method to automatically produce invoices for the employment agency to present to its clients for services rendered.

For the foregoing reasons, there is a need for a time and attendance system, method, and software product that manages and keeps track of workers distributed among different facilities during different periods of time, with different positions and salaries, and that enables the checking of the workers time cards and automatic invoicing.

### SUMMARY

The present invention is directed to a time and attendance system, method and software product that satisfies the need for keeping track of workers that work in different facilities and in different positions and with different salaries at different points in time.

A time and attendance system having features of the present invention comprises:

(a) a computer comprising an at least one database and an at least one clock means for recording time stamps of workers punching in and out;
(b) worker object means in said at least one database for storing an information of each of said workers;
(c) job title object means in said at least one database for storing salary data in relation to job title data; and
(d) a time card means within said computer responsive to said time stamps, said worker object means, and said job title object means, for generating time cards of said workers using said worker object means and using said time stamps with said job title data to calculate salaries of each of said workers.

Optionally, the time and attendance system may also have an invoicing means within said computer responsive to said time card means for preparing invoices. Other optional features are an at least one client computer connected to the computer through a communication link, and a client access means within said at least one client computer for allowing a client to insert and modify said time stamps, said salary data, said information of said workers, and said job title data, and for allowing said client to request said time cards and to accept said time cards. The client access means may be adapted to also allow the viewing of invoices.

In another embodiment of the invention, a time and attendance system having features of the present invention comprises:

(a) a computer comprising an at least one database;
(b) an at least one clock apparatus enabled to record time stamps of workers punching in and out;
(c) a communication link interconnecting said computer and said at least one clock apparatus;
(d) worker object means in said at least one database for storing an information of each of said workers;
(e) job title object means in said at least one database for storing salary data in relation to job title data; and
(f) a time card means within said computer responsive to said time stamps, said worker object means, and said job title object means, for generating time cards of said workers using said worker object means and using said time stamps with said job title data to calculate salaries of each of said workers.

Optional features for the time and attendance system comprise an invoicing means within said computer responsive to said time card means for preparing invoices. Other optional features are an at least one client computer connected to said computer through said communication link, and a client access means within said at least one client computer for allowing a client to insert and modify said time stamps, said salary data, said information of said workers, and said job title data, and for allowing said client to request said time cards and to accept said time cards. Again, the client access means may be adapted to also allow the viewing of the invoices.

In yet another embodiment of the invention, a time and attendance system having features of the present invention comprises:

(a) a computer comprising an at least one database;
(b) an at least one clock apparatus enabled to record time stamps of workers punching in and out;
(c) a communication link interconnecting said computer and said at least one clock apparatus;
(d) worker object means in said at least one database for storing an information of each of said workers;
(e) job title object means in said at least one database for storing salary data in relation to job title data and invoicing data in relation to said job title data; and
(f) a time card means within said computer responsive to said time stamps, said worker object means, and said job title object means, for generating time cards of said workers using said worker object means and using said time stamps with said job title data to calculate salaries of each of said workers.

Similar to the previous embodiments, as an alternative, the time and attendance system may comprise an invoicing means within said computer responsive to said time card means and to said job title object means for preparing invoices, an at least one client computer connected to said computer through said communication link, and a client access means within said at least one client computer for allowing a client to insert and modify said time stamps, said salary data, said information of said workers, and said job title data, and for allowing said client to request said time cards and to accept said time cards. Once more, the client access means may also be adapted to allow the view of the invoices.

A method within a time and attendance system, or a method for the internal operation of a time and attendance system, may comprise the following steps:

(a) recording time stamps that correspond to punches of workers clocking and punching and in and out;
(b) relating job title data to a work period of one of said workers if one of said time stamps is for clocking in; and
(c) stop relating said job title data to said work period if one of said time stamps is for clocking out.

Additional steps for the method mentioned above may be generating time cards according to the punches, and calculating salaries for each said work period of each said worker with said job title data related to said work period. Furthermore, when profits are to be derived from the services of the workers, the method may also comprise the steps of calculating profits for each said work period of each said worker with said job title data related to said work period and generating an invoice with said time cards, inserting said profits in said invoice.

Also, a time and attendance system may be implemented on a general purpose computer with a software or computer program product. The software product should have the proper instructions that cause the computer to perform the desired functions. A computer program having features of the present invention comprises:

(a) storing instruction means for causing said time and attendance system to store

job titles and a salary data for each one of said job titles;

(b) personnel instruction means for causing said time and attendance system to store personal data of workers;
(c) input storing means for causing the said time and attendance system to store inputs from users of said time and attendance system, said inputs comprising time stamps that correspond to moments in which said workers punched in and out; and
(d) time card means responsive to said storing means, personnel means, and input storing means, for generating time cards of said workers using personnel means and using said time stamps and said job titles to calculate salaries of each of said workers.

The computer program may also have additional instructions or features to cause a computer to perform additional functions. These additional features may be synchronization means for synchronizing said input storing means, said storing means, and said personnel means with a central system; where said central system comprises:

(a) central storing means for storing

said job titles and said salary data for each one of said job titles;

(b) central personnel means for storing said personal data of workers;
(c) central input storing means for storing said inputs from users of said time and attendance system.
The software may also comprise an invoice means responsive to said time card means for generating invoices.

The invention itself, both as to its configuration and its mode of operation and its features, aspects, and advantages, will be best understood by the following detailed description of a preferred embodiment taken in conjunction with the accompanying drawings and appended claims. Additional objects and advantages thereof will become apparent with the following detailed description of a preferred embodiment taken in conjunction with the accompanying drawings and appended claims.

The Applicant hereby asserts, that the disclosure of the present application may include more than one invention, and, in the event that there is more than one invention, that these inventions may be patentable and non-obvious one with respect to the other.

Further, the purpose of the accompanying abstract is to enable the U.S. Patent and Trademark Office and the public generally, and especially the scientists, engineers, and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

### BRIEF DESCRIPTION OF THE DRAWINGS

The accompanying drawings which are incorporated herein constitute part of the specifications and illustrate the preferred embodiments of the invention.

FIG. 1A illustrates a computer connected through a communication link to a terminal or clock apparatus with a sensor;

FIG. 1B illustrates a system diagram of a computer with the time and attendance system;

FIG. 2 illustrates a computer, a clock apparatus with a sensor, and a client computer, all connected through a communication link;

FIG. 3 is a flow diagram illustrating the operation of an embodiment of the present invention;

FIG. 4 is another flow diagram illustrating the operation of an embodiment of the present invention;

FIG. 5 is another flow diagram illustrating the operation of an embodiment of the present invention;

FIG. 6 is another flow diagram illustrating the operation of an embodiment of the present invention;

FIG. 7 is another flow diagram illustrating the operation of an embodiment of the present invention;

FIG. 8 is another flow diagram illustrating the operation of an embodiment of the present invention;

FIG. 9 is another flow diagram illustrating the operation of an embodiment of the present invention;

FIG. 10A is another flow diagram illustrating the operation of an embodiment of the present invention;

FIG. 10B is another flow diagram illustrating the operation of an embodiment of the present invention;

FIG. 10C is another flow diagram illustrating the operation of an embodiment of the present invention;

FIG. 11 is a flow diagram of the means for a software product of a time and attendance system;

FIG. 12 is another flow diagram of the means for a software product of a time and attendance system;

FIG. 13 is another flow diagram of the means for a software product of a time and attendance system;

FIG. 14 is an exemplary embodiment of a client management screen of the time and attendance system, in accordance with the present invention;

FIG. 15 is an exemplary embodiment of a salary configuration screen of the time and attendance system, in accordance with the present invention;

FIG. 16 is an exemplary embodiment of an invoice configuration screen of the time and attendance system, in accordance with the present invention; and

FIG. 17 is an exemplary embodiment of a graphical interface of a client access means.

### DESCRIPTION

The present invention relates to a time and attendance system, its software product that sets instructions for the system, and the method of operation.

A “computer”, for purposes of this specification and the claims, is any general purpose computer or data processing machine, such as servers and mainframes. Another important aspect of the invention is that it is able to manage the punches from workers.

For purposes of this specification and the claims, “punches” may be categorized as follows:
(1) A “clock in”, which is the first punch, representing a worker starting a work period;
(2) A “punch out”, which represents any time that a worker stops working, for example, when a worker takes a break;
(3) A “punch in”, which represents when the worker comes back to work during a work period; and
(4) A “clock out”, which represents when the worker finishes a shift or work period.
All punches result in a time stamp in the time and attendance system. A punch is not necessarily produced by the worker. A worker may forget to properly punch through the time and attendance system. Therefore, punches may be manually inserted in the system by authorized users. For purposes of this specification and the claims, the time between a clock in and a clock out is a “work period”.

There may be different types of parties and users that benefit form the present invention. A typical scenario would involve an employment agency, a client of the employment agency, and employees of the employment agency. The client would contract the agency for services. As an example, imagine a hotel contracting with an agency to have extra workers come in during an unexpected high volume of visits to the hotel. Agency employees would go and do the work requested under different positions (bartender, waiter, room service, etc.). These different positions are identified as job titles. A job title will at least depend on the client and the position, and may also depend on other factors such as the department or division within the client's organization and the facility or grounds of operation. Notice that the workers are employees of the agency, and may work at different facilities belonging to different clients, under different payment salaries and conditions. The way that the invention handles this is by relating to each job title a salary and conditions corresponding to the job title.

Another possible implementation is having a single party use the invention for its own operation, without an employment agency being involved. For example, a parent company may implement the invention to manage its own personnel in different locations, and to also manage the personnel of its affiliates and subsidiaries.

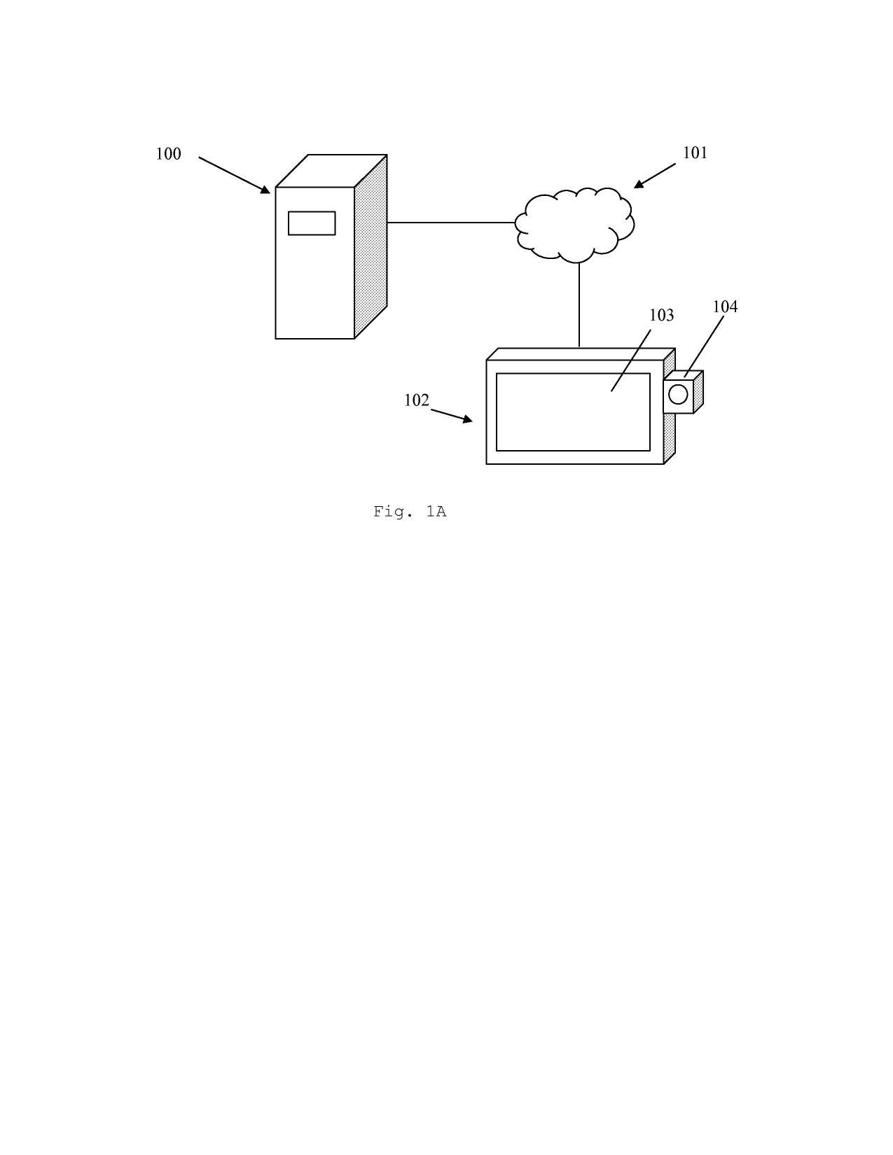

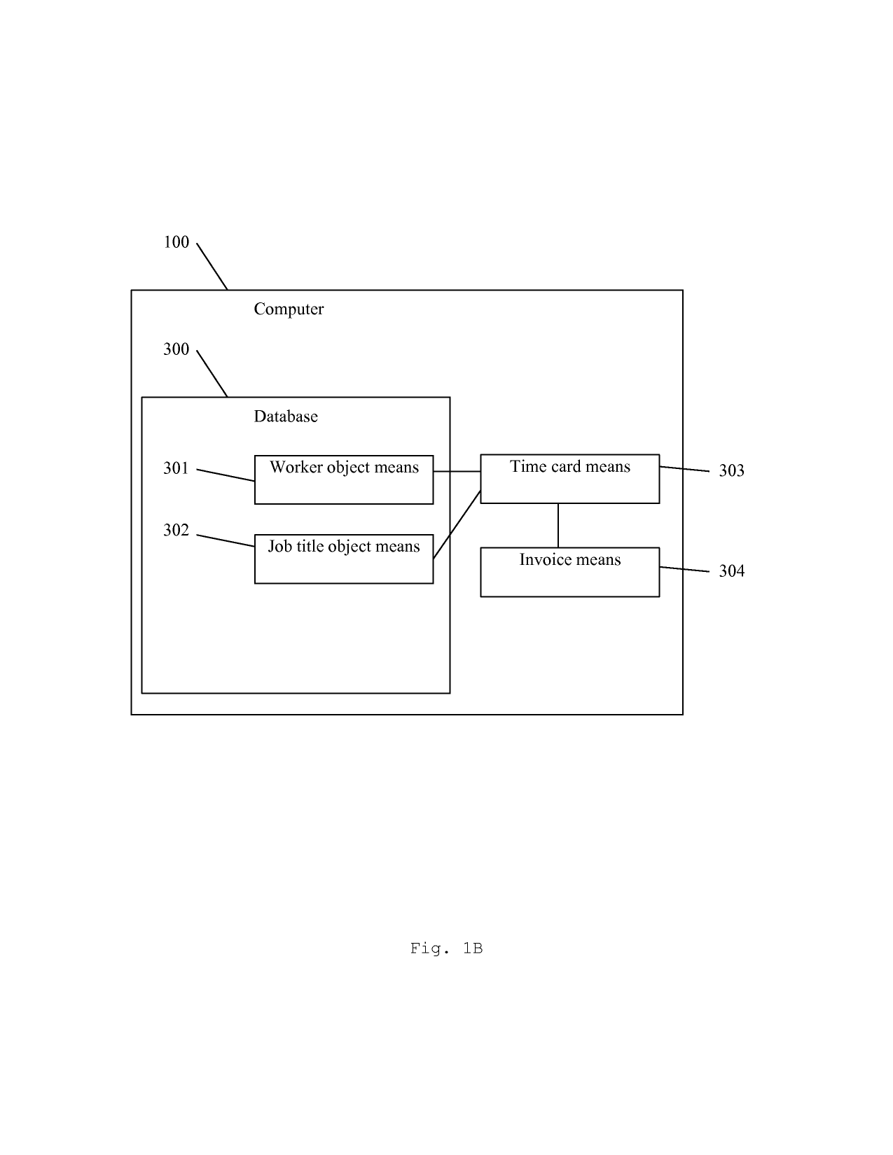

FIG. 1A shows a time and attendance system with a computer 100 connected through a communication link 101 to a terminal or clock apparatus 102. The computer 100 may have a database. For example, the database may be implemented through mySQL. The database could also be simple text files with data organized in manner adapted for the operation of the system. However, a relational database is recommended for the implementation of the invention. A general purpose computer 100 will have a processor (CPU), an operating system, a main storage, and most often will have input/output resources and a user interface with a manually operated keyboard and mouse. The system may use the main storage to save important data (such as job titles, salaries, and other data related to the time and attendance system), or may use the database to organize and collect the data.

The communication link 101 may be implemented through any type of digital or electronic communication. Examples are wireless (GSM, 802.11, etc.) protocols, wired connections, or even manual transfers (taking data into a media device, such as a USB memory stick and transferring it back and forth form the clock apparatus to the server). However, a permanent internet connection is recommended. The clock apparatus 102 may have different input and output interfaces, such as buttons, keyboards, and touch pads. FIG. 1A shows clock apparatus 102 with a touch screen 103. The clock apparatus 102 also has a sensor 104. The sensor 104 shown in the figure is an exemplary embodiment of a fingerprint scanner, but the sensor may be a hand scanner, a retinal scanner, an identification scanner, a badge reader, or any other type of reader or biometric scanner.

To set up a clock apparatus 102, one may purchase a touch screen computer-type terminal, install a unix or linux operating system, and run the clock software only and as a daemon (software that permanently runs on the computer) that does not allow access to the underlying system. That way, unauthorized workers and users cannot stop the operation of the clock apparatus 102. Furthermore, the casing of a clock apparatus 102 should be one such that ports and access points to the hardware are not accessible, making it as difficult as possible to hack into the system. Adding wireless connectivity would enable a connection to the communication link 101 that may not be stopped by unplugging or cutting a cable, and adding an on-device power supply would enable operation even if a worker unplugs the power.

A clock means (for example, a clock means in a computer 100) and a clock apparatus 102 would likely run in with algorithms. The clock means would operate so that the computer 100 or clock apparatus 102 (or other device) would receive input from a user (generally a worker or employee, but may also be a supervisor or administrator changing a time stamp or making some other change), so that the system may record time stamps of workers. A clock apparatus 102 would also have software in its background with instructions to perform the same function, recording the time stamps.

FIG. 1B shows the system view of the time and attendance system, with a database 300 inside the computer 100. Inside the database 300 is the worker information stored by the worker object means 301 and the job title data and salary data stored by the job title object means 302. These pieces of information could just be stored outside an organized database, but a database will generally improve the organization and access of the data. Worker information refers to general information such as name, addresses, social security number, phone, age, gender, civil status, alimony status, and status of paperwork and documentation for work (such as work visa, I-9, number and driver's license expiration date), etc. The worker object means 301 provides the mechanism to collect and store the job title and salary information.

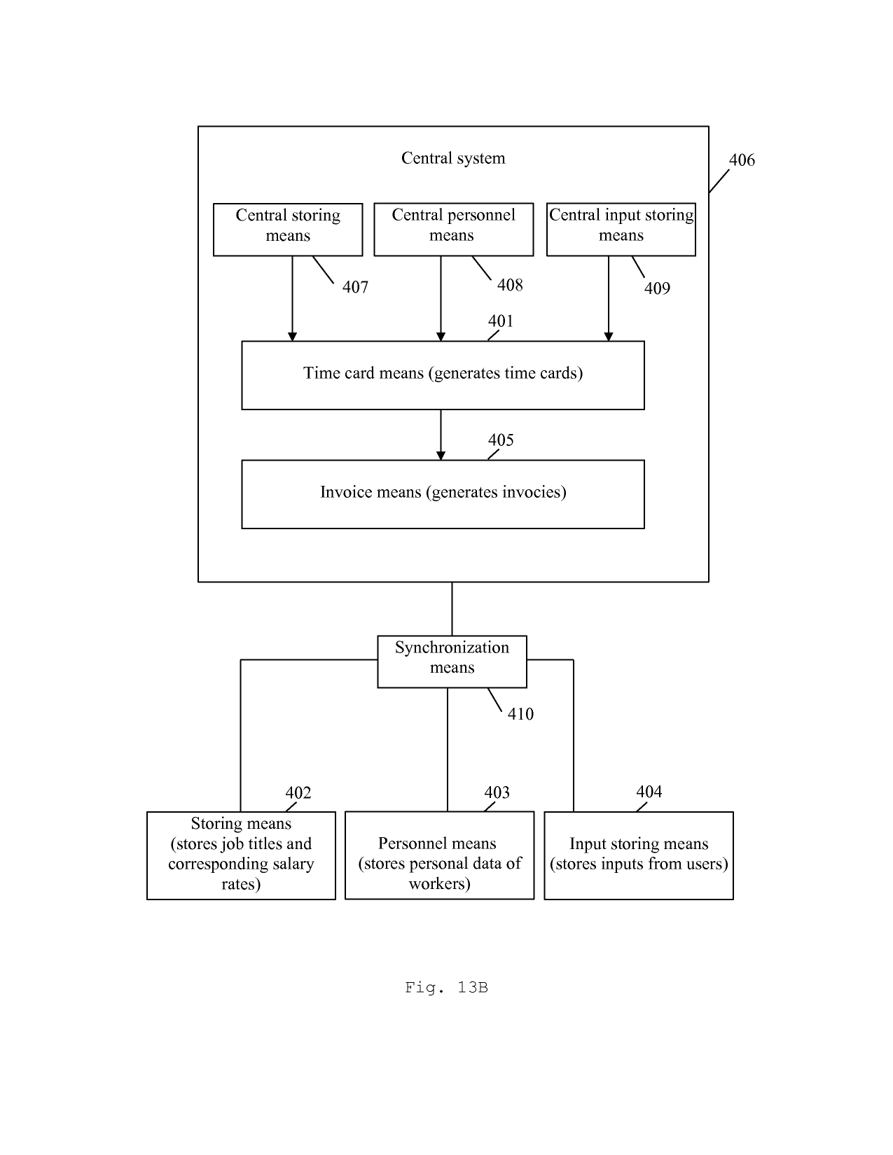

Job title data involves the job title, which company and department to which the job title belongs. When the time and attendance system is being implemented by an employment agency, the job title data may also include the agency's brand, division, or department which provides the employee services (see FIG. 12). Salary configuration occurs through the job title. So the salary data is set for every job title. Salary data comprises the salary type (hourly or fixed salary), the pay frequency, the amount, and the overtime multiplier, if applicable. Other settings, such as if the worker earns tips or commissions, how to handle meal penalty, and how long are their breaks or lunch times, may be added or configured through the salary configuration. The job title object means 302 provides the mechanism to collect and store the job title and salary information.

The time card means 303 procures the necessary information to provide partial time cards or regular time cards. Partial time cards are time cards that are not final because there is a clock out missing for a work period of a particular worker. A time card will generally refer to a regular time card, which may be used to pay salaries.

Either through the job title means 302, through the time card means 303, or though some other means, the computer 100 is to be instructed to tie or relate each work period to a job title. Once the work period and the job title are related, either the relation may be stored, or the corresponding salary data for that particular job title at that particular time may be stored. That information may be used by the time card means to prepare time cards.

With time card prepared, the invoice means 304 may prepare invoices, by setting instructions to computer 100 to prepare invoices. The job title object means sets up the tool for the invoice configuration with respect to each job title.

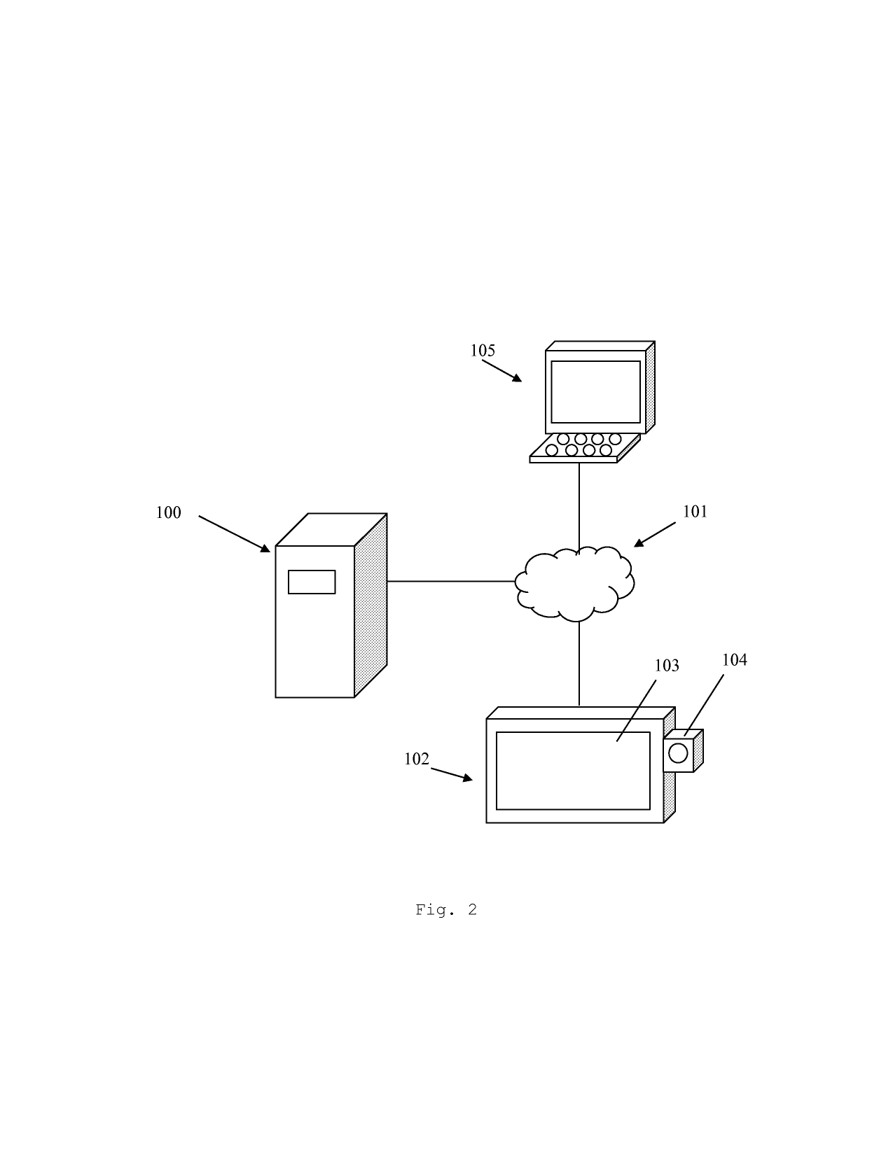

FIG. 2A shows the same configuration as FIG. 1, but adds a client computer 105 connected to the communication link 101.

The time and attendance system may be configured to have multiple terminals or clocks 102. More than one clock apparatus 102 may be installed at convenient locations for workers coming into and leaving work. The system may be configured so that any clock apparatus 102 may be used to punch or clock in, and that any other clock apparatus may be used to clock or punch out, as may be convenient for the workers, the client, or both. Furthermore, the time and attendance system does not need a clock apparatus 102 to work. A clock means may operate to function as a clock, having the clock means installed at the computer 100 or at the client computer 105. The clock means may be a software, code or computer program that instructs the computer to function, at request, as would the clock apparatus 102. This could be the configuration for a small business that does not need or want or cannot have a clock 103 installed. Alternatively, the clock means may be implemented through additional hardware, which may have additional software, that is added or coupled to the computer 100 or to the client computer 105. Additional clock means may be installed on additional computers, as a client may request.

Clients may also request to have the computer 100 to be located on the client's premisses. This is likely to happen in cases in which the client wants to run the time and attendance system for itself or for its own personnel. As it will be shown, the time and attendance system may run personnel and handle time and attendance for workers that belong to different agencies or employers. A client may have remote access to the computers, and hierarchical access to the system may be configured in order to enable different workers, agents and employees with different responsibilities, different access and authority to modify information in the system.

An implemented system will have programed and configured the information of the client. The information of the client and how it is configured in the system may vary depending on the needs of the client, but will generally comprise data about the client (name, contact information, person in charge, phones, emails, addresses, etc.), data about its employees or workers (names, phones, civil status, birth date, address, phone, email, data on employment related documents, photo of the employee, etc.), data about the locations and campuses and places of business or operation of the client, data about the departments or divisions at each location, data about positions or jobs in each department, and the salaries for such jobs, and data about the contact information for the supervisors of each department or job, or combinations of the different types of data mentioned. All these pieces of data may be stored in one or more databases, located in one or more computers. The different pieces of data may be managed by different modules or systems within a time and attendance system or by separate modules or pieces of software, such as a human resources system managing the worker data. When workers or employees quit or are fired, they may be disabled form the time and attendance system. When workers are hired, they may be added to the system.

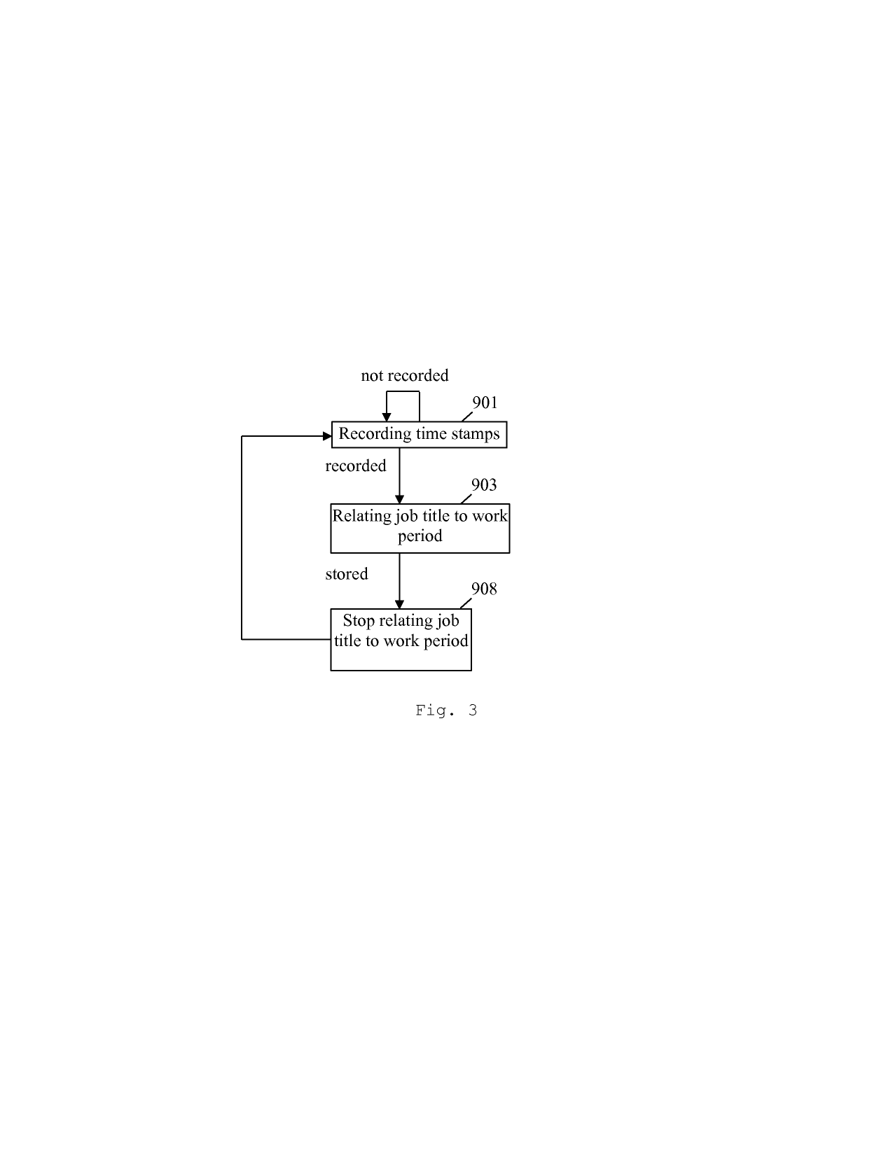

FIG. 3 shows an overall process that may be implemented in, with, or through a time and attendance system. Recording step 901 involves the recording of time stamps. Recording may occur as a consequence of the regular operation of the time and attendance system, or through the manual modification of time stamps by authorized users. Because the working periods and salaries are directly affected by the time stamps, a proper time and attendance system should keep track and store all transactions. For example, if an employee clocks out or punches out, but stays working for any reason, and a few days later a supervisor manually moves the time stamps of the employee to a later time, this will result in an increase in salary for the employee. To add accountability, the system is designed to track all transactions of users. Transactions from users may be stored in a database. Different transactions from different users belonging to different clients may be stored in separate databases.

In FIG. 3, recording step 901 loops back to itself, as if the system was on stand by, while not recording time stamps. Once there is a time stamp, the next step 903 is to relate the job title to the work period. The last step 908 is to stop relating the job title to the work period, once the employee stops working

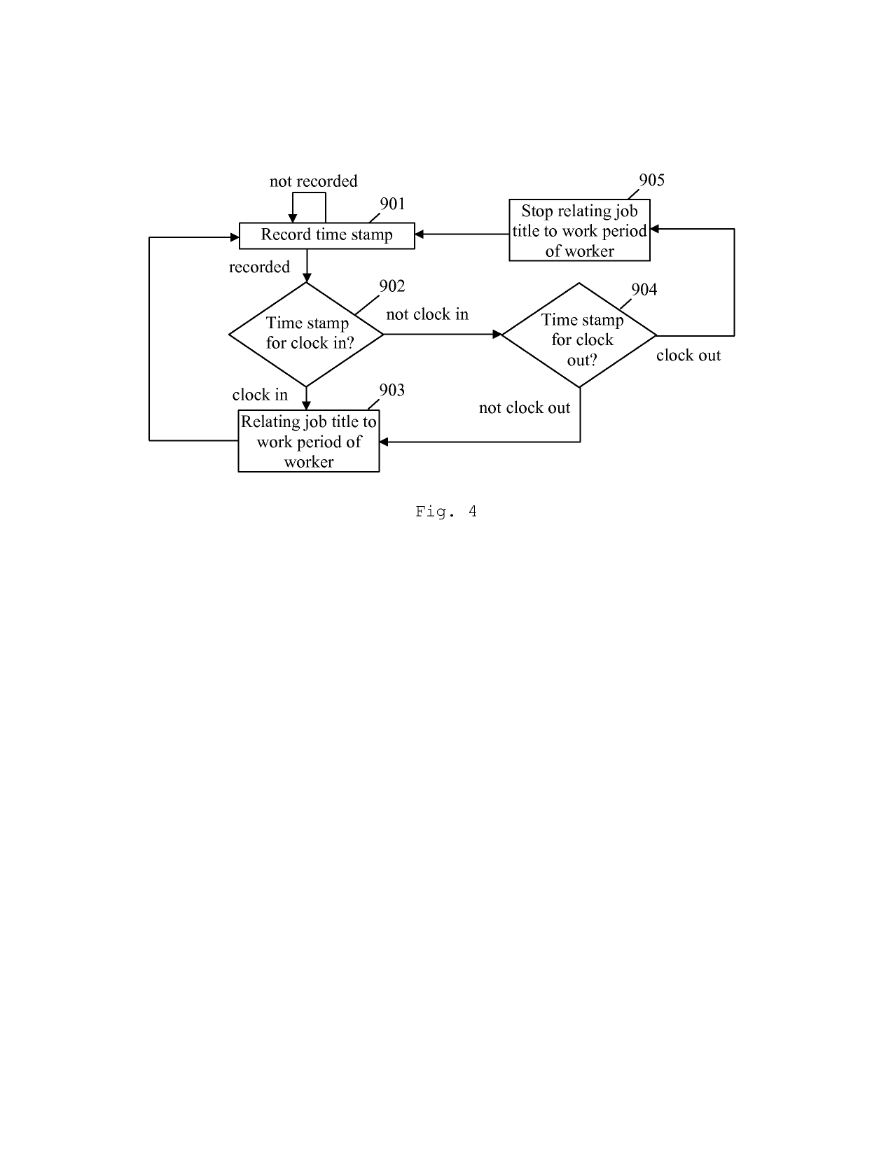

FIG. 4 is a more accurate example of how the process works. The process is on stand by until a time stamp occurs at recording step 901. After the time stamp is captured and recorded, through step 902 the system has to check if the time stamp corresponds to a “clock in”. If it does, the system recognizes and stores the beginning of a “work period”. The employee has to be paid for this work period, so the system starts to relate the job title for the employee for that work period in particular at step 903. There are different ways for the system to know what is the job title of the worker. If the process occurs by the employee clocking in, thereby executing step 901, at a clock apparatus 102, then the clock apparatus 102 may provide the mechanism for the worker to indicate the position such as a graphical interface through which the worker may input the job title. The clock apparatus 102 would generally be in at the client's location, where the employee will work. Therefore, in most cases it would not be necessary to request an input from the worker as to the location. However, if the time stamp is being set by a user or supervisor manually moving or setting a time stamp, then a location may have to be selected in order to select a job title form the job titles available for that location.

After starting to relate a job title to the work period at step 903, the process loops back to step 901 to wait to record more time stamps. Because, after clocking in, a worker may punch out (for example, to go on a break), the system still considers the work period active. A benefit of this is that the system may detect a worker overextending his break or lunch period, and automatically send an alert to supervisors when employees or workers do not punch in after a certain period of time after punching out. So, if the worker has clocked in, the only options are to clock out or punch out (in the case that the worker forgets to punch out or clock out, manual modifications may be required). When a punch out occurs, the time stamp at step 901 leads to step 902, in which the process is to check if the time stamp is for a clock in. The answer is no, so the process follows to step 904, in which the system checks if the time stamp is for a clock out. The answer again is no, so the decision is to go to step 903, and continue relating the job title to the work period. If at step 902 the time stamp had corresponded to a clock out, the process would still lead to step 904, but then the process would follow to step 905, to stop relating the job title to the work period. Another possibility is that a worker, after clocking in and then punching out, comes and punches back in. The time stamp for punching in at step 901 takes you to step 902, and the process is to check if the time stamp is for a clock in. Again the answer is no for a punch in, which lead to step 904 to check if the time stamp is for a clock out. After a punch in, the system should keep the relation between the work period and the job title, and the system correctly follows to step 903 after the punch in time stamp through the evaluations at steps 902 and 904.

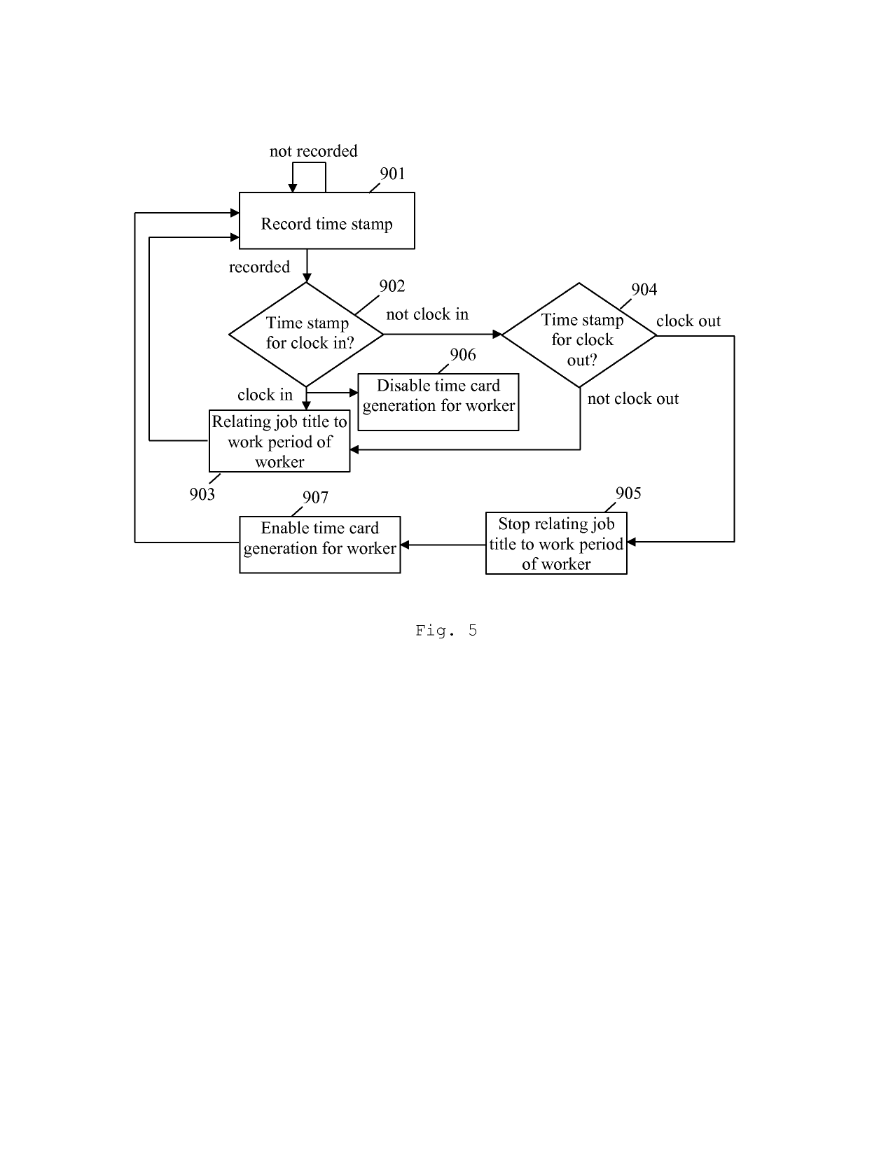

FIG. 5 is a modified flowchart of the process of FIG. 4. Here, the idea is to disable the generation of time cards after an employee clocks in until the employee clocks out. Although partial time cards may be provided by the system and process, and real time status of work may be provided, the purpose of the process as show in FIG. 5 is to disable the generation of a final time card (regardless of whether such final time card is a paper, hard copy, electronic or virtual time card) that may be used to pay the employee or for the worker to claim wages. This makes sure that if a worker randomly leaves a shift without clocking out, supervisors will have to address the shift and work period of that worker to generate a time card, without loosing the ability to verify the time stamps currently registered in the system and the real current status of the worker with a partial time card. The process achieves this by adding a step 906 after step 902, if the time stamp recorded is a clock in. Step 906 disables time card generation in the system. Once time cards are disabled for a particular worker (because the worker clocked in), they stay disabled until the worker clocks out at step 904. After a clock out at step 904, the process follows to step 905 to stop relating the job title to the work period of the worker, and then the system allows time card generation for the worker at step 907.

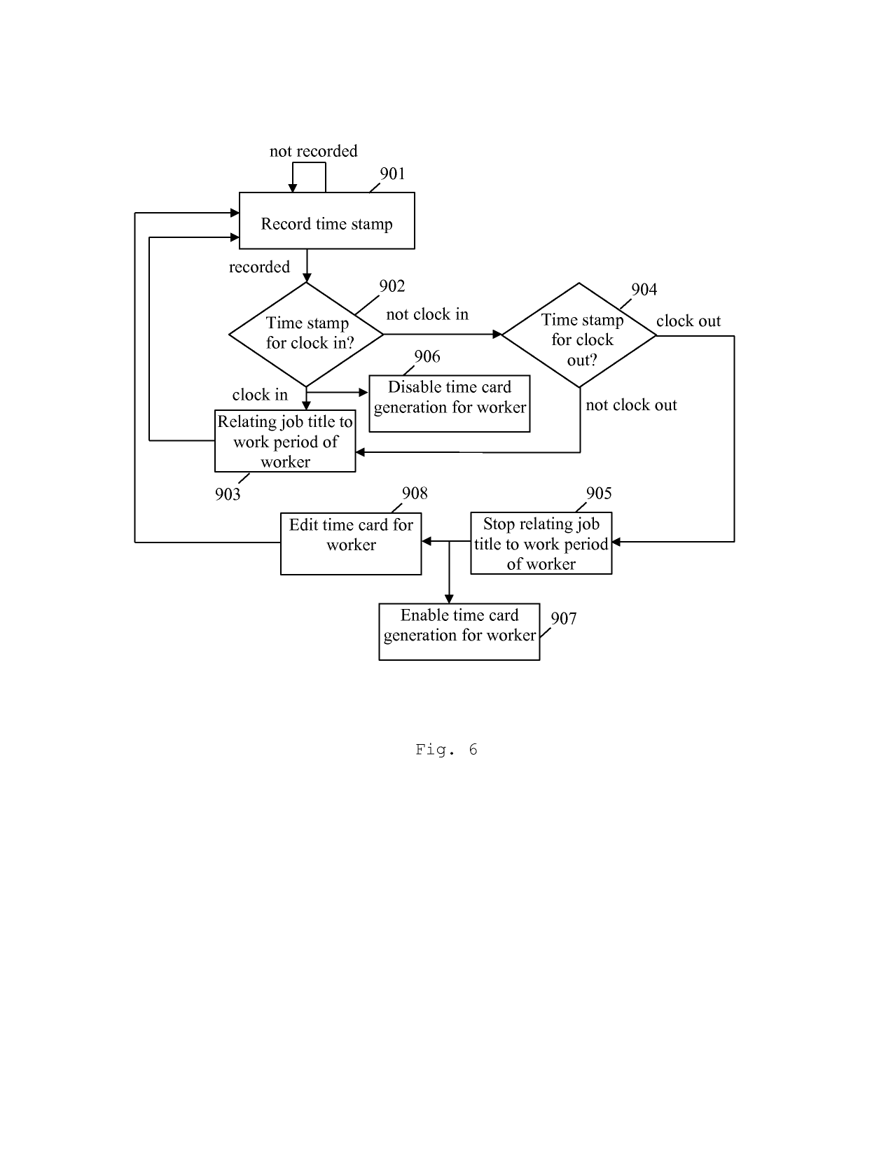

FIG. 6 is like FIG. 5, but with a modification that explicitly presents an edit time card step 908 to manage time cards. The idea is to present as part of the method the modification to a final time card. In FIG. 6, step 908 edits the time card that corresponds to the worker. The editing may involve the entry into the time card of the work period, with the time stamps for clock in, punch out's, punch in's, and the clock out. If the time card is to include salary information, the editing may also involve the inclusion of the data related to the linking of the work period to the particular job title data for that work period. Alternatively, the editing may involve the inclusion of the salary for that job title directly into the time card. The steps 907 and 908 at FIG. 6 may be alternated, or placed in sequence one after the other in any order, instead of having them occur at the same time as appears in FIG. 6. An advantage of placing the steps in sequence, with enabling time card generation step 907 occurring after stop relating job title to work period step 908, is that a time card may not be generated while the time card is being edited.

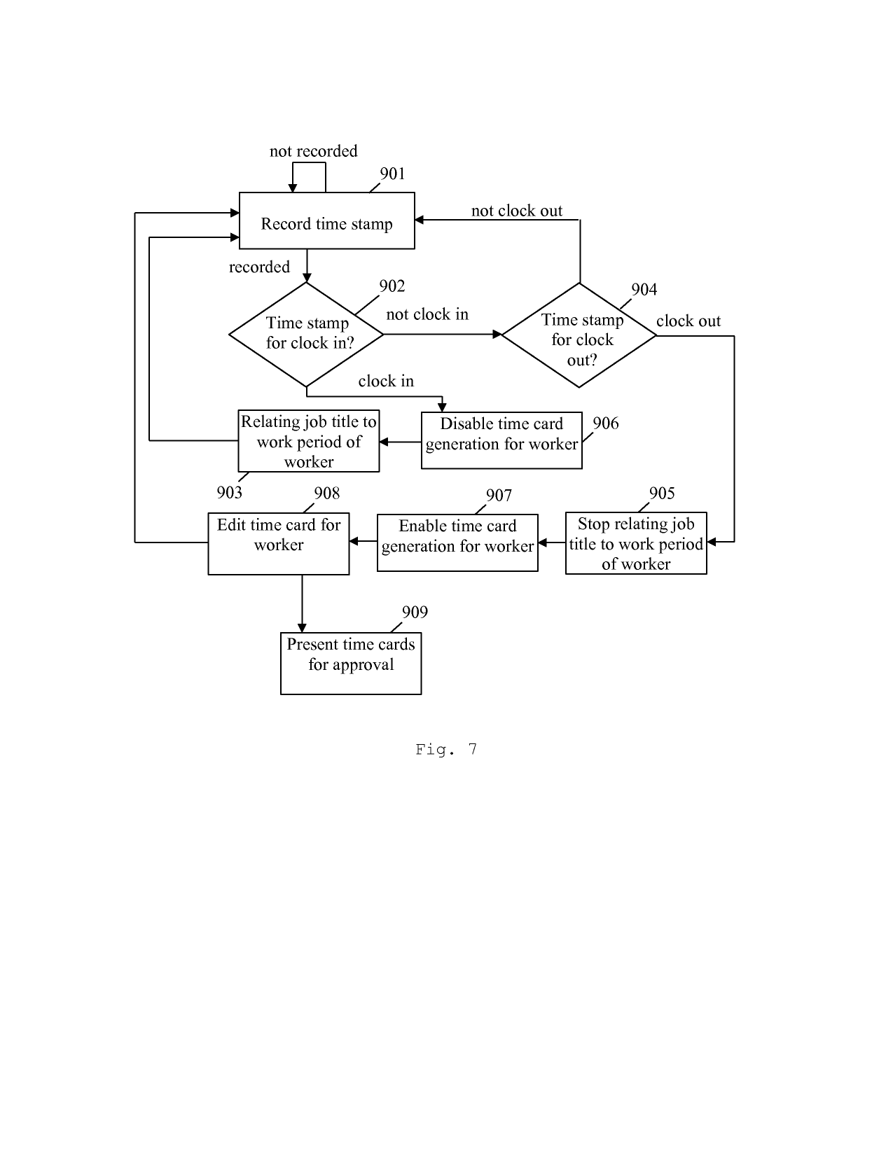

FIG. 7 is also a modification of previous FIG. 6. Notice that after the time stamp check at step 902, if the time stamp is a clock in, the process flow goes disable time card generation step 906 and then goes on to relate the job title to the work period of worker step 903. FIG. 7 also shows that after step 904, if the time stamp is not for a clock out, because redundancy is not required, the check for clock out time stamp step 904 leads back to record time stamp (stand by) step 901. As to steps 905, 907 and 908, they are shown in sequence, with 907 occurring first. Another step that may have been placed in sequence, but was placed to occur as a consequence of editing time card step 908, is presenting time cards for approval step 909 (in FIG. 7, editing time card step 908 still loops back to step 901). The presenting time cards for approval step 909 may be modified for situations so that the step fits the operation of the particular business running the time and attendance method. For example, step 909 may occur with the clock out of every worker if the employer chooses so. Alternatively, the presentation of time cards may occur when a particular period, such as a weekly period, has elapsed. Step 909 does not have to occur at every instance that time cards are edited through step 908. Regardless of whether the time cards are daily time cards, weekly time cards, or corresponding to other periods, step 909 provides for the review and approval of said time cards. Come the end of a period, daily, weekly or otherwise, when step 909 is to occur, the step will not go through for a worker that has clocked in for a particular work period and has not clocked out, because for such a worker the enable time card generation step 907 has not occurred for a particular work period. It is also convenient for step 909 to include the bringing up of an alert when a time card cannot be generated for one or more workers. Time card approval requests and alerts from step 909 may be presented through the time and attendance system or through emails or through graphical interfaces for supervisors, directors, or the corresponding personnel to review, correct, and approve. A time and attendance system may implement any of the alternative embodiments of the method so that the presentation of time cards for approval and alerts occurs automatically without a request.

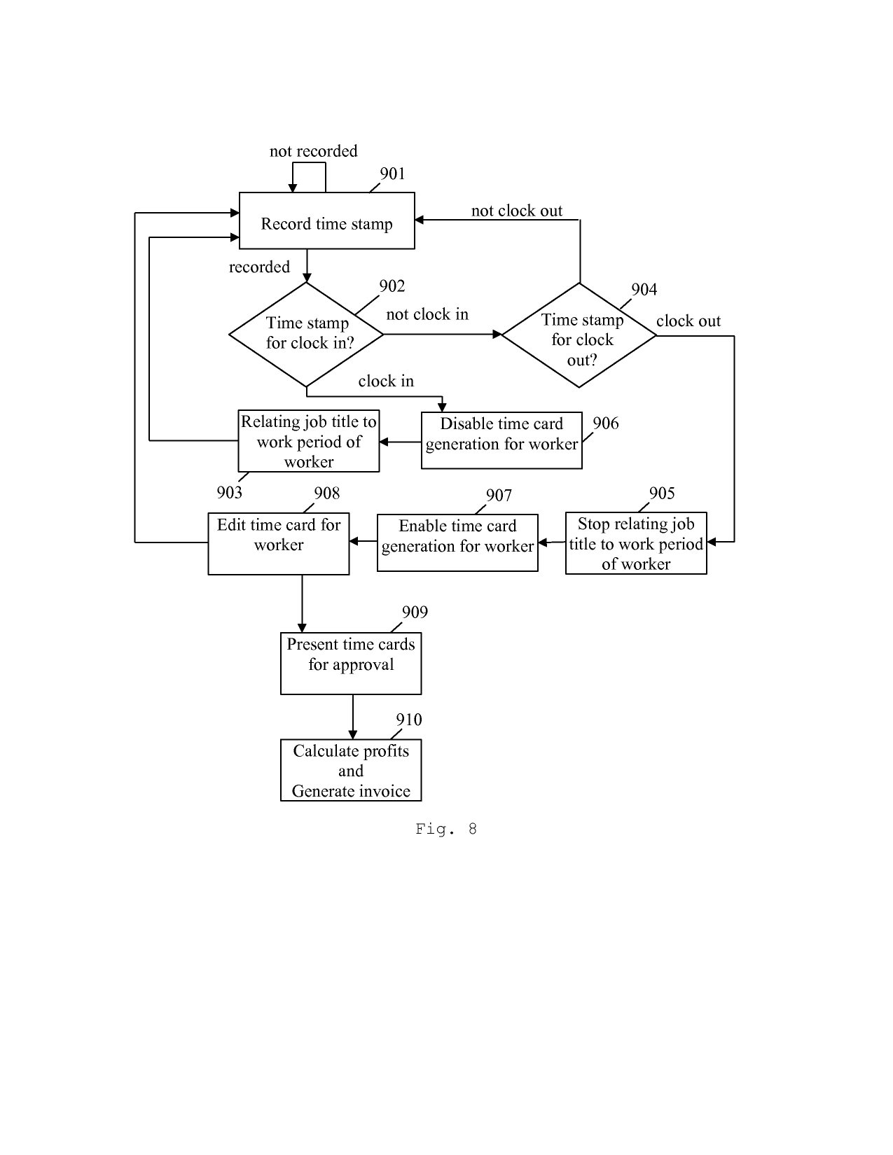

FIG. 8 is like the method of FIG. 7 with an additional calculating profits and generating invoice step 910. This step is useful for the situations in which there is an employment agency providing services to a client. The method as in FIG. 8 may be configured so that the generation and delivery of the invoice from the agency to the client occurs automatically. Notice that if the system is configured to proceed with the process automatically at all steps, the system and method provide a great advantage. At step 909, time cards may be provided automatically to the client, reducing the possibility of human error. The client may review them and approve them through the time and attendance system. The time cards may also be presented with or within the invoice generated at step 910. Notice that job title data is not the only way to feed salary information into the time cards and invoices. If the worker has a fixed salary, that salary may be set to be approved through the time cards and invoices.

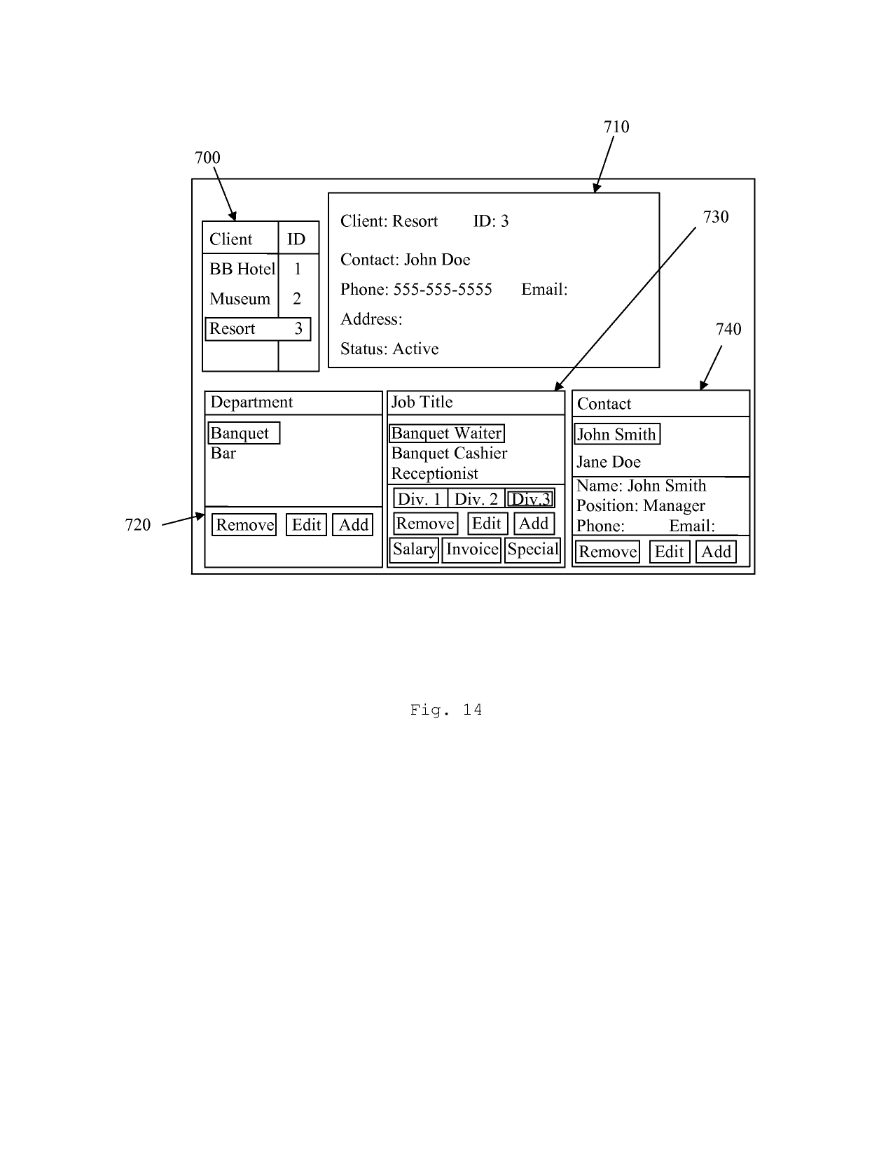

The calculation of profits may be configured as agreed between the client and the agency. For example, the agreement between the agency and the client may be that there will be a profit of a fee 40% of all salaries paid to workers. Whichever the calculation is, the configuration for it may be achieved through a graphical interface. The invoice configuration tool is part of the client configuration tool, which generally will have a graphical interface for ease of operation. In normal circumstances, only the agency and its personnel should have access to the client configuration tool and its components. An embodiment for the client configuration tool is shown in FIGS. 14 to 16.

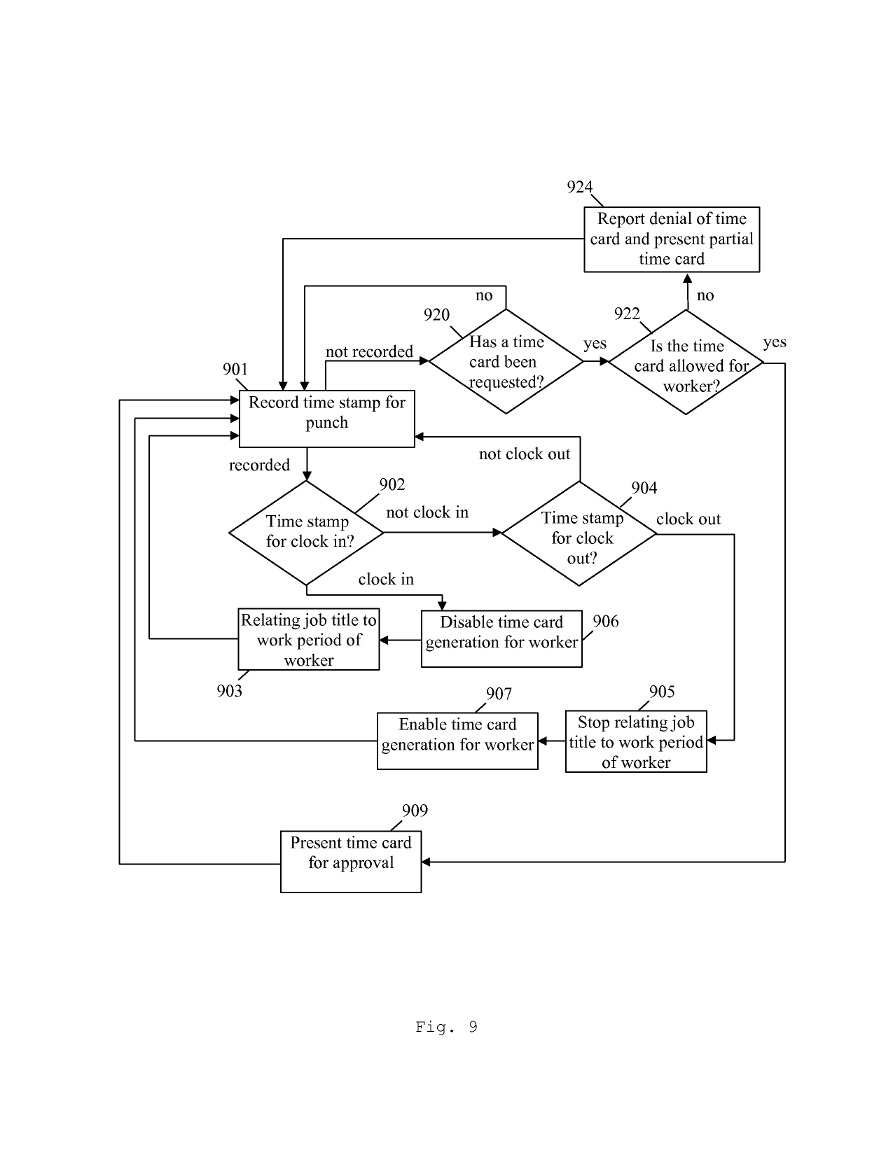

FIG. 9 is yet another modification to the process as show in FIG. 8. In FIG. 9, steps for managing the requests for time cards are explicitly presented. While there is no time stamp being recorded at step 901, the process stands by and checks if a time card has been requested at time card request check step 920. Time cards may be requested manually or automatically (automatic final time cards come out at a predetermined moment, such as the end of a week or a month, and generally come out as a result of a request for time cards for a group of workers). If no time card has been requested at step 920, the process loops back to step 901. If a time card has been requested, the process goes from step 920 to time card allowed check step 922. At step 922, the system checks if the time card requested may be provided, generally by checking if step 906 has not disabled the generation of time cards. Notice that step 922 may be configured to avoid generation of all types of time cards, as in those that are partial or just to check the work progress of a worker in real time plus those that are final time cards (which if assumed to always be allowed, then all partial time cards would follow to step 909). Step 922 may also be configured to check allowance only for final time cards, or time cards that will be used for salary payment, and not to check for or deny allowance for partial time cards or non-final time cards.

Notice also that in FIG. 9, all types of time cards may be generated at step 909, the process reaching step 909 only when there is a request for a time card at step 920 (whether the request is automated or manual). This is because after the request for the time card, if the time card is allowed at step 922, then the process follows to the present time card for approval step 909. The level of approval and modification allowed may vary depending on the authority of the user that requested the time card. A worker who should not be allowed to modify time stamps in the past may use a clock apparatus 102 to see the hours he or she has worked, and may have a complaint or disagreement as to the hours and punches reflected by the system, or may see that in a particular day he or she forgot to clock out, or may also see that when clocking out he or she forgot to punch back in after a lunch punch out. The system and method may be configured so that only a supervisor with authority is allowed to alter these punches, and to correct punches that occur in the past. An proper time and attendance system and method would keep a history of all transactions, including which user accessed the system and added, deleted, or changed a time stamp or a punch, as this could be used to find irregularities and improper punches and time stamps. After the time card allowance check at step 922, if the time card is allowed, the process follows with the presentation of the time card at step 909. After the time card allowance check at step 922, if the time card is not allowed, the process follows with the report of a denial of the time card and if possible, presents a partial time card at step 924. After step 924, the process goes back to step 901.

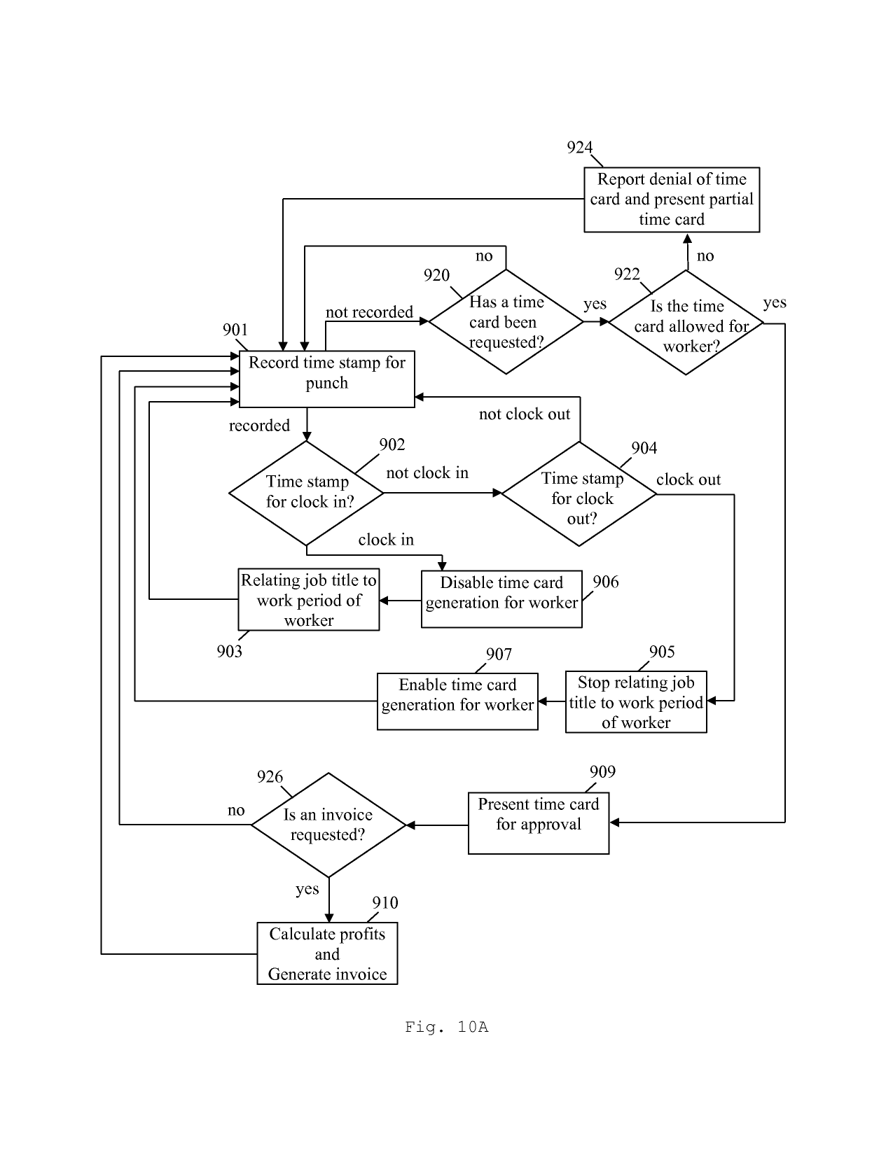

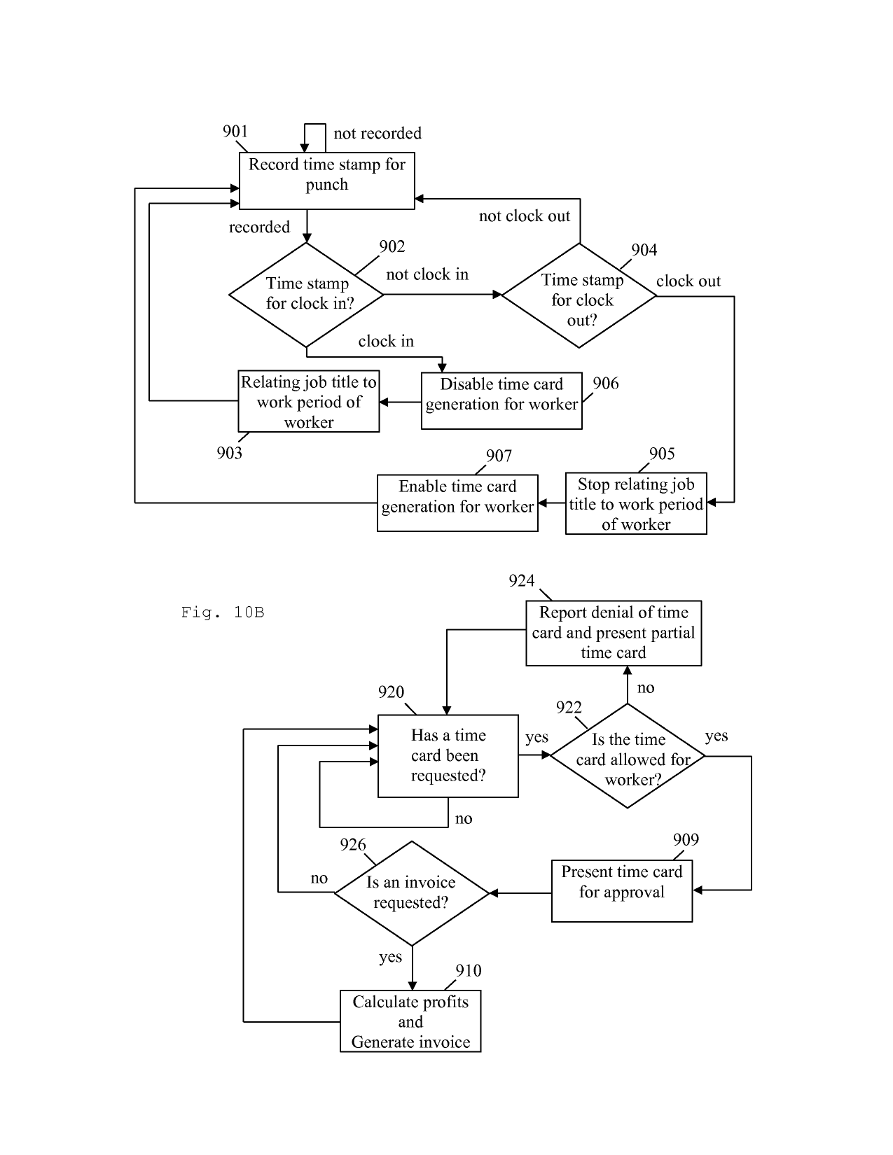

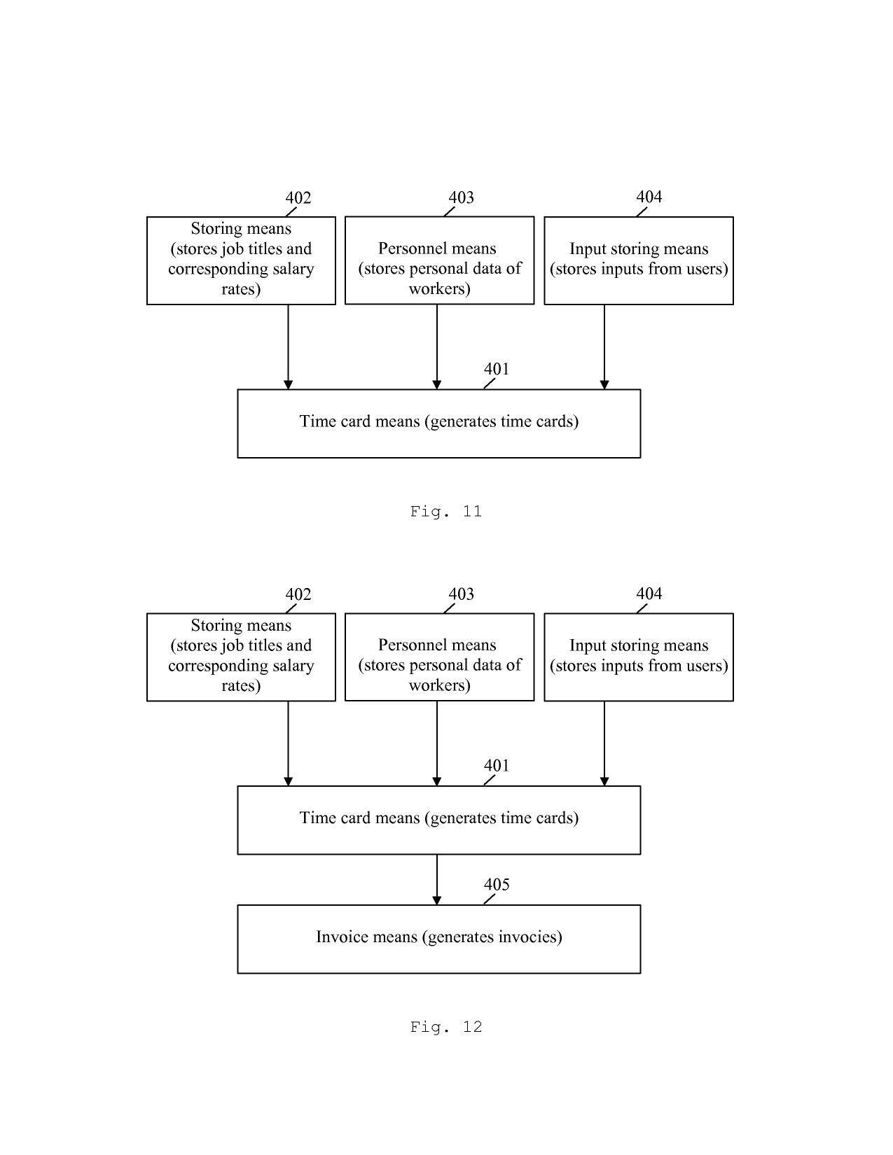

Although FIG. 9 does not present a calculate profits and generate invoice step 910, such a step is presented in FIG. 10A. FIG. 10A is very similar to FIG. 9, but after the present time card step 909, it checks if there is a request to generate an invoice at step 926. If there is no request for an invoice, the process follows back to the stand by/record time stamp step 901. If there is a request for an invoice at step 926, the process follows to calculate the profits and generate an invoice at step 910. After the invoice is generated, the process follows back to the stand by/record time stamp step 901. This invoice management may be implemented on a worker by worker basis, or on a group of workers, and the process and system may be configured to allow only worker by worker requests, group requests, or to allow both.

Because invoice management will generally be implemented with agencies and their clients, a way to have the process implemented is by creating a client application, (for example, a computer program that runs at client computer 105) that accesses the server or computer 100 (which runs the software, database, and system for the time and attendance system). A second alternative, which may be implemented by itself or parallel with the client application, is to have a web-based access portal to the time and attendance system for the client. Either the client application or the web-based portal would have a graphical user interface presented to the user and connect the client computer 105 to the computer 100 through a communication link 101. When the communication link is the internet, the system may be configured so that computer 100 only accepts connections from a particular client computer 105, or any client computer 105 that is connected or using the internet protocol number of those computers located at client's center of operations or place of doing business, thereby reducing the possibility of rogue users connecting to the time and attendance system in attempts to hack the system, or having users access the system outside of their workplace. Notice that the system may be configured in a way so that the web-based portal does not run a computer program other than a web browser, which browses through the internet, and reaches the appropriate computer or server (for example, computer 100) which allows a view into the time and attendance system. Likewise, a client application may be configured in a way so that it uses the internet to reach the appropriate computer or server (for example, computer 100) which allows a view into the time and attendance system through the client application.

FIG. 10B is similar to FIG. 10A. FIG. 10B shows two sets of steps running in parallel. It is like FIG. 5 but with disable time card step 906 coming first in series with relating job title to work period of worker step 903, and with additional steps running in parallel. These additional steps are the steps found in FIG. 10A that are not in FIG. 5. The additional steps are configured in the following manner: the system checks if a time card has been requested at step 920. If no time card has been requested, the system waits for a request. Once there is a request, the process follows to check if the time card is allowed for the corresponding worker at step 922. This will depend (similar to how it is described and shown for the previous figures) on disable time card generation step 906 and on enable time card generation step 907. As explained before, these steps respond to whether or not the worker has clocked out after a clock in. If the time card is not allowed at step 922, then the system goes to step 924 to report a denial of the time card and to present a partial time card. Presentation of the partial time card will generally show the point where the worker did not clock out, to ease the correction of the clocking. After step 924, the system goes back to step 920. If the time card is allowed at step 922, the system goes to present time card for approval step 909. After step 909, the system checks for an invoice request at step 926. The system and process could be configured so that time cards have to be approved before an invoice is requested, or configured so that an invoice request automatically approves the time cards. If no invoice is requested the process goes back to step 920, but if the invoice is requested, the process goes on to calculate profits and to generate an invoice in step 910. After invoice generation at step 910, the process goes back to step 920.

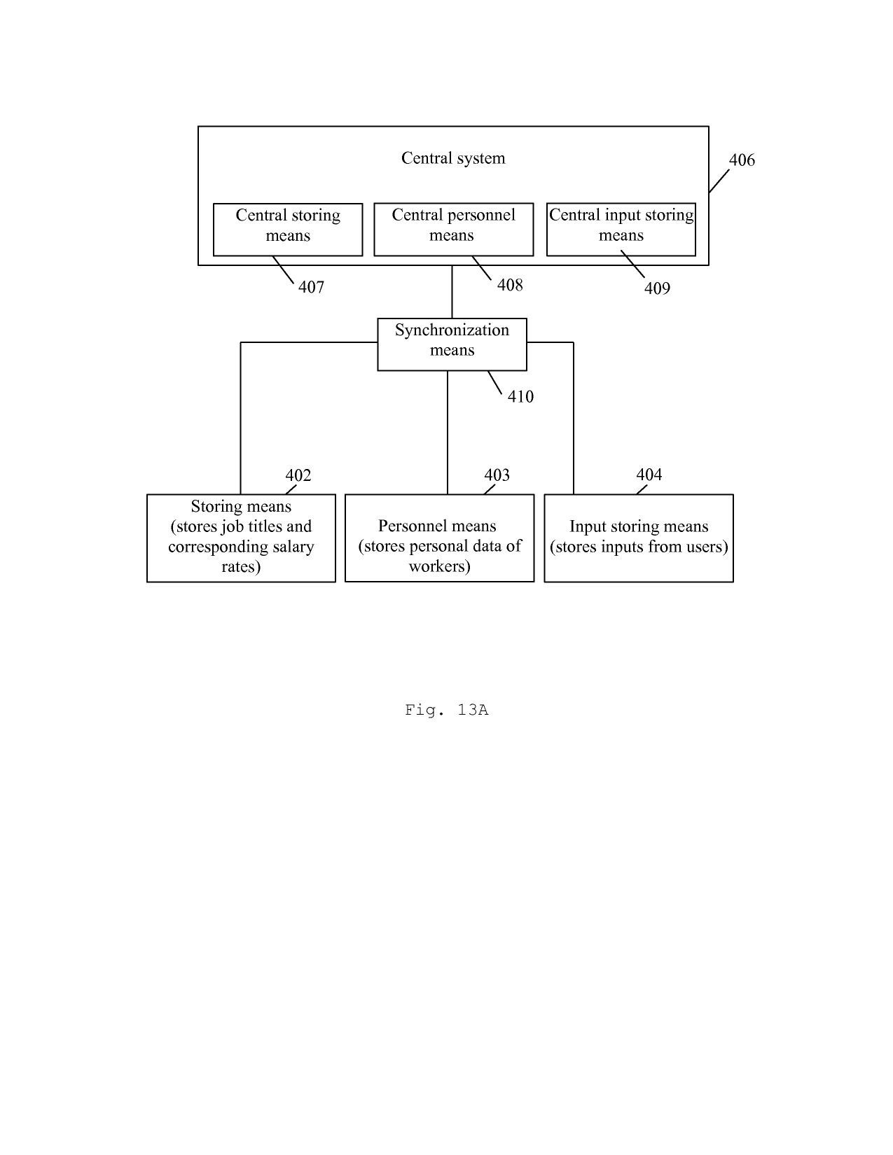

In the implementation of any embodiment of the method may be convenient to insert pauses during the flow of steps. For example, after the presentation of time card for approval step 909, a user may need time to view and approve the time card or time cards presented. The user may also choose to reverse or remove the approval from a previously approved time card. Therefore, the process does not have to instantaneously go through all of the steps. To expand on the previous example, assuming the embodiment also comprises an invoice request check step 926, this invoice check may be configured to happen only while an authorized user is checking time cards, and may be further configured to only be allowed once the time cards are approved. It is also useful to note that when an invoice is generated, particularly when the invoices are generated for the benefit of an employment agency or a third party to the client, then approved time cards may not be disapproved and the invoice may not be reverted, except if and when necessary by authorized personnel. Among the reasons for this is that the employment agency uses the invoicing to pay to the workers that went to work for the client, so allowing the client to later on amend the time cards, their allowance, or their invoicing, allows the client to reduce the amount of money to be paid to the employment agency, when the employment agency may have trusted the previously approved time cards and paid the workers in excess of what the client may reimburse or pay to the employment agency. Ways of implementing different embodiments of the process in different embodiments of the system or through different embodiments of the salary system software of the time and attendance system will become apparent when viewing the exemplary embodiments shown in FIGS. 14 to 17 and the systematic views of FIGS. 11 to 13C.

In general, the disabling of time card generation, for example as in step 906, will be done regarding the particular work period or set of work periods. This avoids the problem of processing time cards or salary management or invoices for a work period in the past (for example, the salary of a worker corresponding to the set of work periods for two weeks in the past) while the worker is currently clocked in and has not clocked out during the day. This may also apply when the worker has not clocked out for a work period that does not fall within the set of work periods that are being used to generate time cards, salaries, or invoices. Also, when presenting time card for approval at step 909, the user does not necessarily have to approve the time card, and the system does not have to require an immediate approval. A user may have the need to verify information or may not be ready to approve time cards. Also, particular users may not have the authority to approve time cards, and those should only be able to view but not approve the time cards.

FIG. 11 shows a system view of an embodiment of the invention. It comprises a storing means, personnel means, input storing means, and time card means. Although a general implementation will contain all the mentioned means in a computer or server, such as computer 100, the different means may be distributed each by themselves and as a whole among different computers, servers, mainframes, virtual machines, environments, etc., all which would be equivalent to computer 100. The computer or computers will generally have a processor or a CPU or central processing unit, a storage memory, a monitor, and input devices such as keyboard, mouse, and touchscreen. Each of the mentioned means may be implemented through code or computer programs or routines that enable a general computer, such as computer 100 or its equivalents, to perform particular functions.

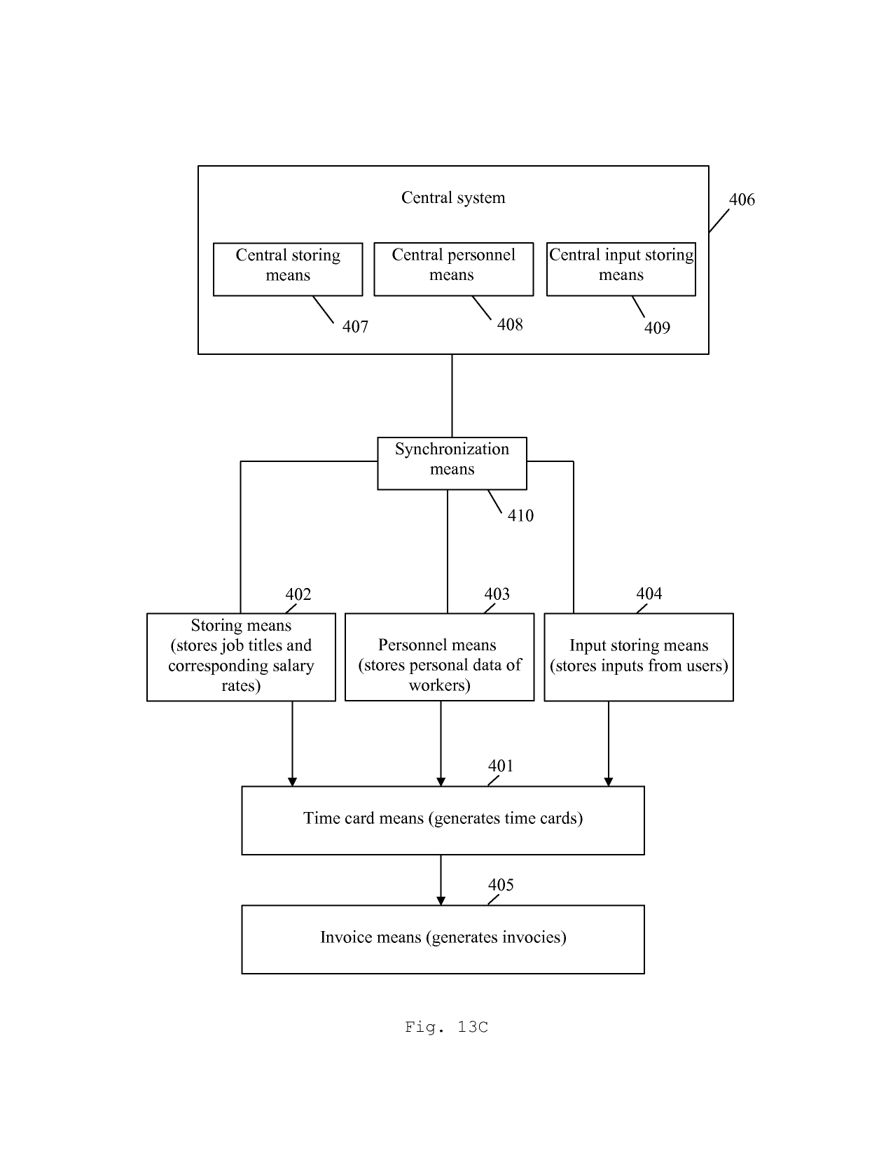

In FIG. 11, storing means 402 stores job titles and their corresponding salary rates. The personnel means 403 stores personal data of workers. The input storing means 404 stores inputs form users of the system. The storing means 402, the personnel mean 403, and the input storing means 404 send the data that each of them stores to a time card means 401, so that the time card means is able to generate time cards with the data received. The different mentioned means, including those that will be mentioned as parts of FIGS. 12 and 13, may be configured to store the data in the memories of computer 100 or its equivalents, and may be configured, stored, or adapted to store and retrieve data from memory storage, from one or more databases, from text files, or from any other appropriate mechanism of data or memory storage.

FIG. 12 expands on the system as shown in FIG. 11 by adding an invoice means 405 for generating invoices. The invoice means 405 received data (for example, the time cards) form time card means 401 in order to prepare the invoices. Generally, an employment agency will invoice a client with a calculation based on the amount of time or work that workers have spent or done for the client. This time spent or work done is reflected in the time cards. An example would be that the profit agreed between the client and the employment agency is 25% of the salary of the workers. If the workers are paid $10 an hour, and a worker worked for 10 hours, the salary is $100 and the additional profit is $25. The invoice means 405 stores this profit information for profit calculation, receive the salaries form the time card means, calculate the profit, and prepare the invoice. To follow through with the example, the invoice would be for $125 (the salary plus the profit), and may present the general data and calculations information so that any person viewing the invoice can understand the calculations and the hours and rates on which the invoice is based. In an alternative embodiment, the profit information could be stored in storing means 402, and have the profit information sent to the invoice means 405 from storing means 402 or through time card means 401.

FIGS. 13A and 13B are similar to FIGS. 11 and 12, but show a central system 406 and a synchronization means 410. The FIGS. 13A and 13B is to show a system view of a central system 406 and the local components synchronizing through the synchronization means 410. The idea, however, is to show a system that may operate without synchronization or connection to the central system (for example, when a communication link 101 fails, or when a synchronization means 410 fails, such as when the internet connection or other connection fails, so that clock apparatus 102 or client computer 105 cannot connect to computer 100).

FIG. 13A is representative of the software components and the corresponding means in a time and attendance system that may have one or more clock apparatuses 102. A storing means 402, a personnel means 403, and a input storing means 404 are located at the clock apparatus 102, or in each one of a plurality of clock apparatuses 102. This enables the clocking in and out, and the recording of punches and information of workers at each clock apparatus 102, even if the clock apparatus 102 cannot connect to the computer 100. The central system 406 has a central storing means 407, a central personnel means 408, and a central input storing means 409, all which are analogous to the storing means 402, personnel means 403, and input storing means 404, respectively, and synchronize through the synchronization means 410.

FIG. 13B is like FIG. 13A, but with the additional time card means 401 and invoice means 405 located within central system 406. The time card means 401 is connected to invoice means 405 to enable the generation of invoice based on time cards, as previously explained in the description of FIG. 12. However, in FIG. 13B, the time card means 401 receives data from the central storing means 407, central processing means, 408, and central input storing means 409. The difference between the embodiments as shown in FIG. 13B versus FIGS. 11 and 12 is that in FIG. 13 the functions for time card and invoice generation are programmed or embedded in the central system 406 (or found within the main software of the time and attendance system), whereas in FIGS. 11 and 12 the time card means (and the invoice means for FIG. 12) are implemented outside the central system 406, or as a separate software or code or subroutine, that although can communicate with the central system 406, runs on a separate computer, environment or thread.

FIG. 13C may be seen as a mix of FIGS. 12 and 13A, or as a modification of FIG. 13B. It shows central system 406 comprising central storing means 407, central personnel means 408, and central input storing means 409, all synchronizing through the synchronization means 410 with storing means 402, personnel means 403, and input Storing means 404, respectively. storing means 402, personnel means 403, and input storing means 404 connect to time card means 401, as time card means 401 is responsive to them for the generation of time cards. The invoice means 405 is connected to the time card means 401 and receives the time cards in order to generate invoices.

FIG. 14 shows an embodiment of a screen shot of a client management screen. It has a client list 700, which in FIG. 14 is shown with a mock sample list of clients and with a client named “Resort” selected and highlighted and assigned the identification number 3. It also has a client information window 710, which reveals information about the client selected at the client list 700. The client information window 710 may show and allow the insertion of information about the client, such as the client name, the identification number (which may be automatically assigned by the system), contact information (such as addresses, contact person, phones, faxes, emails, and status with the employment agency or party using the system to run the time and attendance of the client). The client management screen also has a department list 720, a job title list 730, and a contact list 740. The department list 720 in FIG. 14 shows a mock list of departments of client “Resort”, including “Banquet”, which is highlighted, and “Bar”. Department list 720 has a set of buttons to enable the addition, removal, or editing of departments within a client. The job title list 730 shows a mock list of job titles within the “Banquet” department highlighted in department list 720, including “Banquet Waiter”, which is highlighted, “Banquet Cashier”, and “Receptionist”. The job title list 730 has a set of buttons to enable the addition, removal, or editing of job titles, as well as a button to call up the salary configuration tool and the invoice configuration tool, and a button named “Special” to add functionality in the future as may be desired by the clients or the programmers. The job title list 730 also has a brand or division bar, which has mock up divisions or brands, including “Div. 1”, “Div. 2”, and “Div. 3”, which is highlighted. The highlighted “Div. 3” means that the employment agency will employ workers from division 3 of the agency, or that the brand of the service under which the workers will provide services is the one corresponding to “Div. 3” The contact list 740 has a mock list of contacts, including “John Smith”, which is highlighted, and “Jane Doe”. Because “John Smith” is selected or highlighted, the contact list 730 shows contact information for “John Smith”, such as name, position, phone and email. The contact list 730 also has buttons to add, remove, or edit contacts.

The tools within the client management screen are configured to assist employment agencies and other general users and service providers to manage their clients. The contact list 740 may include a list of contacts and supervisors for the workers and situations that fall within job title selected at the job title list 730. So, selecting a new job title at job title list 730 changes the information at the contact list 740. The job title list 730 allows for the management of salaries and invoices through the corresponding mentioned tools, which facilitates the manner in which and employment agency invoices its clients, and assists the clients in the tracking of invoices. Selecting a different department at the department list 720 changes the list of job titles at job title list 730. Likewise, changing the client at client list 700 changes the available departments at department list 720. Generally, when the employment agency engages a client, or changes the offering of services, salaries, or the contractual or profit terms, the client management tool will be used to add or remove clients, departments, job titles, contacts, or to change the salary or invoice terms as necessary.

One easy way to prepare a relational database to manage this information is to create a table or database for clients. Then, create a table or database that manages departments for each client. Even if the departments repeat within different clients, there may be different job titles within the equal departments depending on the client, so it may be beneficial to repeat the creation of a department for a new or different client. Afterward, a table or database for job titles could be created, with the salary and invoice configuration for each job title in the same table or database, or in different ones. Likewise, a separate table or database with contacts could be created. Once the tables or databases are created, the client management tool may be configured so that the addition, removal, or editing of information may be done from the tool, populating the different tables or databases with information. Notice that in FIG. 14, the client list 700 does not have buttons for the addition, removal, or editing of clients. The user of a system may be limited as to the access and permissions to change information, and in case of a user with a screen as in FIG. 14, the user is not allowed to alter the list of clients in the system.

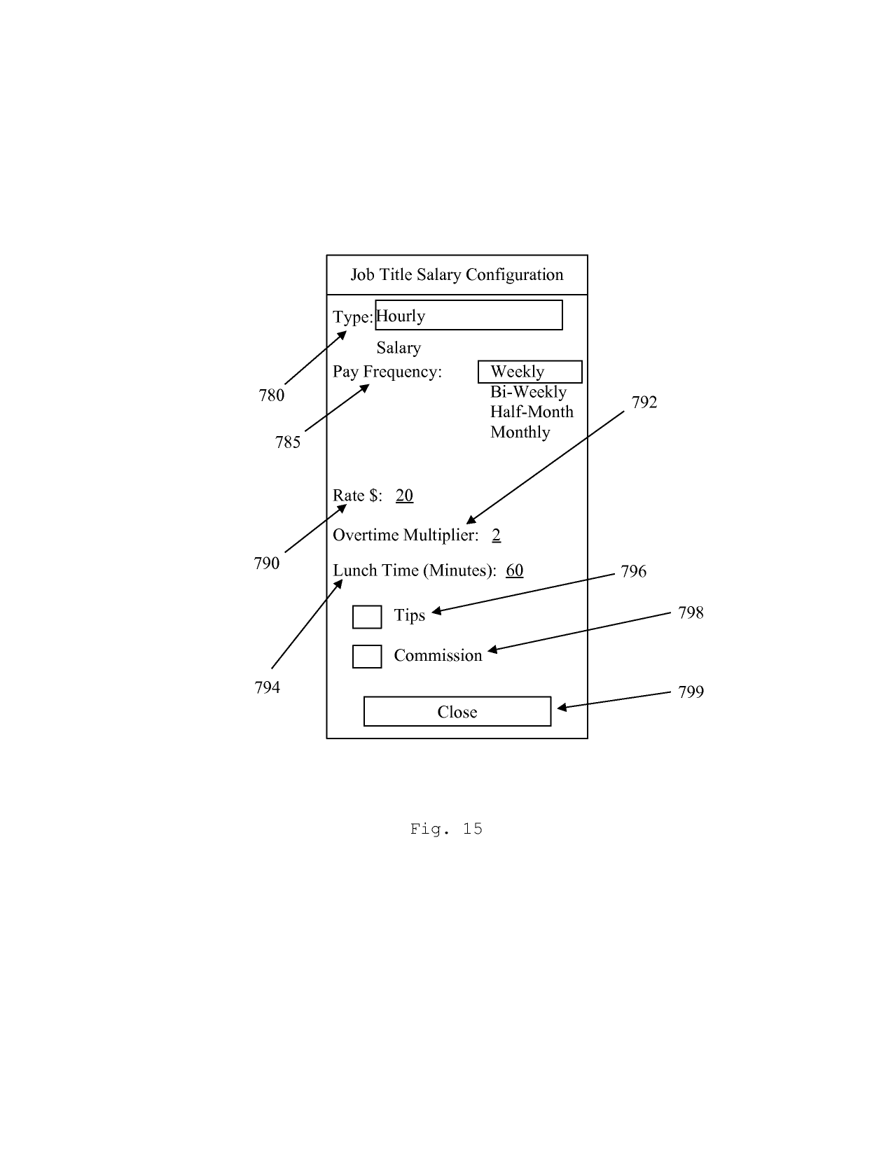

FIG. 15 shows the screen of a screen of a salary configuration tool. This screen may come up as a pop up, or as a new screen, or the options within may be otherwise provided for the configuration of the salary of a particular job title, or for a set of job titles (particular job titles may also be pre-configured). At the screen, the salary type object 780 provides the choice between “Hourly”, which is highlighted, and “Salary”. “Hourly” sets an hourly rate for payment under the job title, while “Salary” sets a fixed pay rate. Other salary types may be created and programmed. The pay frequency object 785 in FIG. 15 shows a set of sample choices, including “Weekly”, which is highlighted, “Bi-Weekly”, “Half-Month” and “Monthly”, each representing sets of periods in which workers would be paid. This pay frequency setting 785 may be directly related to the previous explanation about the disabling of time card generation, for example as in step 906, which may be done regarding the particular work period or set of work periods. As previously explained, smart disabling of time card generation for particular periods avoids the problem of processing time cards or salary management or invoices for a work period in the past (for example, the salary of a worker corresponding to the set of work periods for two weeks in the past) while the worker is currently clocked in and has not clocked out during the day. One way for the system to know which period to consider for salary payment and for allowance of time card generation or invoice generation is to look at the period set at pay frequency object 785. Next, the salary configuration tool shown provides for setting the salary rate at salary rate object 790, which because of the salary type 780, is an hourly rate. In FIG. 15, the salary rate object 790 is filled in with a salary of $20 per hour. This could be further adapted to allow the configuration of how to pay for fractions of an hour, and how to divide such fractions. Other optional features shown are the overtime multiplier object 792, used to set the factor with which to multiply the hourly rate when a worker goes into overtime, and a preset period for lunch time at lunch time object 794. To indicate if the job title corresponds to positions that receive tips or commissions, buttons are presented to enable access to the tips object 796 and the commission object 798. Clicking these buttons may alter how a worker is paid. For example, a waiter that receives tips or a worker that is paid by commission may be paid a lesser amount than what would otherwise be paid by the client or the employment agency if tips collected by the waiter or the commissions received by the worker reach or exceed a particular amount. Once a configuration for a job title is complete, the user may close the salary configuration tool with close button 799.

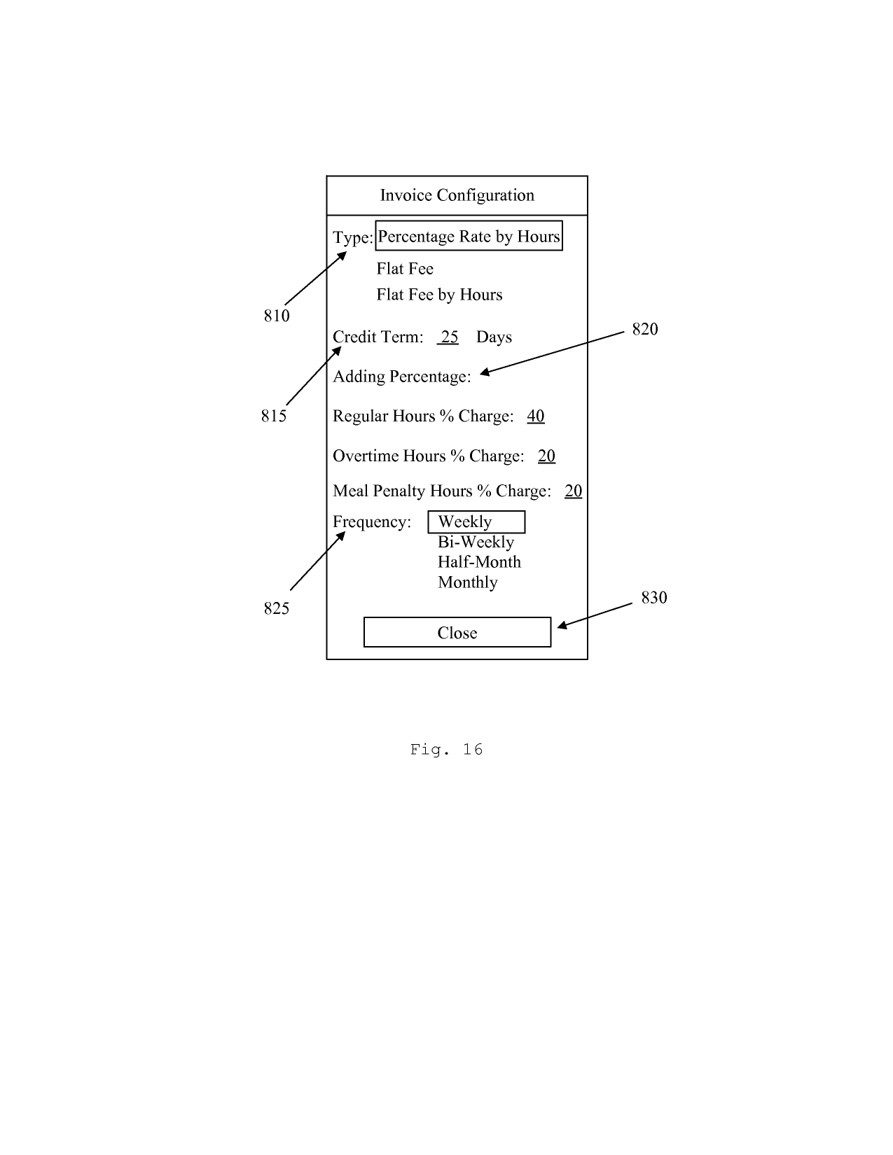

FIG. 16 shows an exemplary embodiment of a screen of an invoice configuration tool. Generally, this tool is used by employment agencies and similar parties using the invention. The embodiment shown has an invoice rate type object 810, with a mock sample of invoice rate types, including “Percentage Rate by Hours”, which is highlighted, “Flat Fee”, and “Flat Fee by Hours”. With the “Percentage Rate by Hours”, an agency is able to charge a percentage of the hourly rate paid to workers, as in the hourly rate that may be set with salary rate object 790 and with overtime multiplier object 792. With “Flat Fee”, the charge goes per engagement or work period, and with “Flat Fee by Hours”, the profit is calculated by charging a fee per hour of work of each worker. Other ways of charging may be programmed and enabled through an invoice configuration tool. The credit term object 815 is set to determine the period in which an invoice is due. The profit setting object 820 enables the configuration of the profits depending on the invoice rate type 810. If the invoice rate type 810 is per flat fee, then the flat fee is set in a particular type of currency. Because FIG. 16 shows “Percentage Rate by Hours” as the rate type selected in invoice rate type object 810, the profit setting object 820 allows the insertion of percentages to be added to the invoiced based on the salary of each worker under the particular job title being configured. The percentages may be set in general, or may be configured to be different depending on if the worker is being paid for regular hours, for overtime, or for meal penalty, or under other purposes. In order to know when to generate invoices for services rendered or otherwise, invoice frequency object 825 may be set to a particular period. In the exemplary embodiment of FIG. 16, the options for invoice frequency are “Weekly”, which is highlighted, “Bi-Weekly”, “Half-Month” and “Monthly”. Once a the invoice configuration is set, the invoice configuration screen may be closed with the invoice configuration close object 830.

It may appear to be redundant to have a pay frequency object 785 set at the salary configuration tool and an invoice frequency object 825 set at the invoice configuration tool. It is not redundant. It is not the same to pay employees than to invoice a client. The system and the software have to manage the need to pay the employees of the employment agency, which are workers for the client, and the fact that the client may unintentionally or purposely delay the approval of time cards or the request of invoices. When an invoice frequency is set, based and selected by the employment agency, the software prepares and stores invoices periodically, even if those invoices are not requested. The software and the system may be configured so that when an invoice is generated, the client cannot change the time cards that correspond to the workers, in order to allow the agency to pay to the employees/workers without the risk of having the client change time cards in order to pay less.

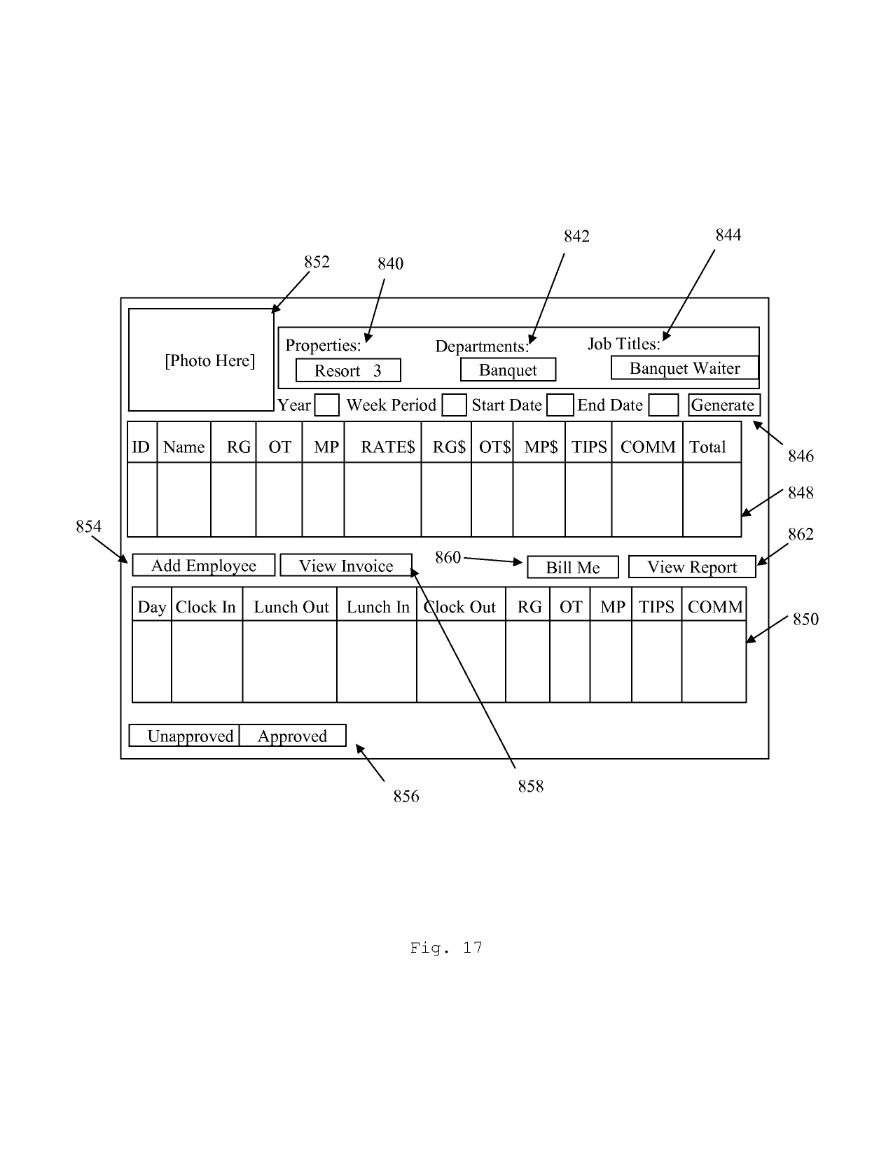

FIG. 17 is an exemplary embodiment of the graphical interface of a client access means. Clients and users may use the interface to operate and access the time and attendance system. The exemplary interface shows a client property object 840, a client department object 842, and a client job title object 844. Because the typical user of a client access means is a client or the personnel of the client, full access generally is not provided. Therefore, the property object means only displays a list of properties or places of business that belong or correspond to the client using that particular instance of the client access means. Notice that the property “Resort 3” selected at client property object 840, the department “Banquet” selected at client department object 842, and the job title “Banquet Waiter” selected at client job title object 844 match mock the client, department and job titles selected at FIG. 14. Generally, selecting a property presents a list of possible departments, and selecting a department presents a list of job titles within the department.

FIG. 17 continues to show a year worker-job generation object 846, with which a user may select a year and a week period or a start date and an end date, and then hit the generate button once a job title is selected. When the user hits the generate button, the general report display 848 is filled in with details that correspond to the period and job title selected. The general report display 848 will show the workers that worked under the selected job title in the selected department of the selected property during the selected period of time. The general report display 848 will also show, row by row, the identification number of the worker, the name, regular ours worked, overtime, meal penalty, the pay rate, the amount earned on regular hours, the amount earned in overtime, the amount earned in meal penalty, the amount earned in tips, the amount earned in commissions, and the total earned for the period. If the user selects a worker from the general report display 848, the time cards display 850 will fill up with the time cards of the worker. As a beneficial tool when supervisor's have many workers, a photo of the worker may be shown at photo display 852. Each time card displayed at the time cards display 850 will show the day of the time card, the clock in, lunch out (punch out), lunch in (punch in), clock out, regular hours worked, overtime hours, meal penalty, tips and commissions earned. The user may select to approve or unapprove a previously approved time card with the approval button 856. If a new employee or worker will be added to the system, the add employee button 854 may be used to enable the integration of the worker into the system. Invoices may be generated with the bill me button 860. Invoices belonging to historical records may be viewed with the view invoice button 858. Summaries and detailed reports may be requested and viewed with the view report button 862.

In all the different embodiments of the processes shown, simple modifications may be implemented to configure different alternative embodiments. For example, instead of relating job titles to work periods, the process may be modified to take the data behind the job titles (for example, the salaries or hourly rates) and directly tie them to the work periods. Also, some steps may be altered in sequence and order with respect to other steps of the method implementations shown.

While the invention has been described as having a preferred design, it is understood that many changes, modifications, variations and other uses and applications of the subject invention will, however, become apparent to those skilled in the art without materially departing from the novel teachings and advantages of this invention after considering this specification together with the accompanying drawings. Accordingly, all such changes, modifications, variations and other uses and applications which do not depart from the spirit and scope of the invention are deemed to be covered by this invention as defined in the following claims and their legal equivalents. In the claims, means-plus-function clauses, if any, are intended to cover the structures described herein as performing the recited function and not only structural equivalents but also equivalent structures.

All of the patents, patent applications, and publications recited herein, and in the Declaration attached hereto, if any, are hereby incorporated by reference as if set forth in their entirety herein. All, or substantially all, the components disclosed in such patents may be used in the embodiments of the present invention, as well as equivalents thereof. The details in the patents, patent applications, and publications incorporated by reference herein may be considered to be incorporable at applicant's option, into the claims during prosecution as further limitations in the claims to patentable distinguish any amended claims from any applied prior art.

The claimed invention is:

1. A time and attendance system comprising:
(a) a computer comprising an at least one database and an at least one clock means for recording time stamps of workers punching in and out;
(b) worker object means in said at least one database for storing an information of each of said workers;
(c) job title object means in said at least one database for storing salary data in relation to job title data; and
(d) a time card means within said computer responsive to said time stamps, said worker object means, and said job title object means, for generating time cards of said workers using said worker object means and using said time stamps with said job title data to calculate salaries of each of said workers.

2. The time and attendance system of claim 1, further comprising:
(a) an invoicing means within said computer responsive to said time card means for preparing invoices.

3. The time and attendance system of claim 1, further comprising:
(a) an at least one client computer connected to said computer through a communication link; and
(b) a client access means within said at least one client computer for allowing a client to insert and modify said time stamps, said salary data, said information of said workers, and said job title data, and for allowing said client to request said time cards and to accept said time cards.

4. The time and attendance system of claim 1, further comprising:
(a) an invoicing means within said computer responsive to said time card means for preparing invoices;
(b) an at least one client computer connected to said computer through a communication link; and
(c) a client access means within said at least one client computer for allowing a client to insert and modify said time stamps, said salary data, said information of said workers, and said job title data, and for allowing said client to request said time cards and to accept said time cards, and to view said invoices.

5. A time and attendance system comprising:
(a) a computer comprising an at least one database;
(b) an at least one clock apparatus enabled to record time stamps of workers punching in and out;
(c) a communication link interconnecting said computer and said at least one clock apparatus;
(d) worker object means in said at least one database for storing an information of each of said workers;
(e) job title object means in said at least one database for storing salary data in relation to job title data; and
(f) a time card means within said computer responsive to said time stamps, said worker object means, and said job title object means, for generating time cards of said workers using said worker object means and using said time stamps with said job title data to calculate salaries of each of said workers.

6. The time and attendance system of claim 5, further comprising:
(a) an invoicing means within said computer responsive to said time card means for preparing invoices.

7. The time and attendance system of claim 5, further comprising:
(a) an at least one client computer connected to said computer through said communication link; and
(b) a client access means within said at least one client computer for allowing a client to insert and modify said time stamps, said salary data, said information of said workers, and said job title data, and for allowing said client to request said time cards and to accept said time cards.

8. The time and attendance system of claim 5, further comprising:
(a) an invoicing means within said computer responsive to said time card means for preparing invoices;
(b) an at least one client computer connected to said computer through said communication link; and
(c) a client access means within said at least one client computer for allowing a client to insert and modify said time stamps, said salary data, said information of said workers, and said job title data, and for allowing said client to request said time cards and to accept said time cards, and to view said invoices.

9. A time and attendance system comprising:
(a) a computer comprising an at least one database;
(b) an at least one clock apparatus enabled to record time stamps of workers punching in and out;
(c) a communication link interconnecting said computer and said at least one clock apparatus;
(d) worker object means in said at least one database for storing an information of each of said workers;
(e) job title object means in said at least one database for storing salary data in relation to job title data and invoicing data in relation to said job title data; and
(f) a time card means within said computer responsive to said time stamps, said worker object means, and said job title object means, for generating time cards of said workers using said worker object means and using said time stamps with said job title data to calculate salaries of each of said workers.

10. The time and attendance system of claim 9, further comprising:
(a) an invoicing means within said computer responsive to said time card means and to said job title object means for preparing invoices.

11. The time and attendance system of claim 9, further comprising:
(a) an at least one client computer connected to said computer through said communication link; and
(b) a client access means within said at least one client computer for allowing a client to insert and modify said time stamps, said salary data, said information of said workers, and said job title data, and for allowing said client to request said time cards and to accept said time cards.

12. The time and attendance system of claim 9, further comprising:
(a) an invoicing means within said computer responsive to said time card means and to said job title object means for preparing invoices;
(b) an at least one client computer connected to said computer through said communication link; and
(c) a client access means within said at least one client computer for allowing a client to insert and modify said time stamps, said salary data, said information of said workers, and said job title data, and for allowing said client to request said time cards and to accept said time cards, and to view said invoices.

13. A method, in a time and attendance system, said method comprising the steps of:
(a) recording time stamps that correspond to punches of workers clocking and punching and in and out;
(b) relating job title data to a work period of one of said workers if one of said time stamps is for clocking in; and
(c) stop relating said job title data to said work period if one of said time stamps is for clocking out.

14. The method of claim 13, further comprising the step of:
generating time cards according to said punches.

15. The method of claim 13, further comprising the step of:
(a) calculating salaries for each said work period of each said worker with said job title data related to said work period; and
(b) generating time cards according to said punches and said salaries.

16. The method of claim 15, further comprising the step of:
(a) calculating profits for each said work period of each said worker with said job title data related to said work period; and
(b) generating an invoice with said time cards, inserting said profits in said invoice.

17. A salary system for computing salaries based on job titles, said salary system residing in a time and attendance system, said salary system comprising:
(a) storing instruction means for causing said time and attendance system to store job titles and a salary data for each one of said job titles;
(b) personnel instruction means for causing said time and attendance system to store personal data of workers;
(c) input storing means for causing the said time and attendance system to store inputs from users of said time and attendance system, said inputs comprising time stamps that correspond to moments in which said workers punched in and out; and
(d) time card means responsive to said storing means, personnel means, and input storing means, for generating time cards of said workers using personnel means and using said time stamps and said job titles to calculate salaries of each of said workers.

18. The salary system of claim 17, further comprising:
invoice means responsive to said time card means for generating invoices.

19. The salary system of claim 17 in which said storing means and said personnel means are responsive to a central system, said salary system further comprising:
synchronization means for synchronizing said input storing means, said storing means,
and said personnel means with said central system;
and said central system comprising:
(a) central storing means for storing
said job titles and said salary data for each one of said job titles;
(b) central personnel means for storing said personal data of workers;
(c) central input storing means for storing said inputs from users of said time and attendance system.

20. The salary system of claim 17 in which said storing means and said personnel means are responsive to a central system, said salary system further comprising:
invoice means responsive to said time card means for generating invoices;
synchronization means for synchronizing said input storing means, said storing means,
and said personnel means with said central system;
and said central system comprising:
(a) central storing means for storing
said job titles and said salary data for each one of said job titles;
(b) central personnel means for storing said personal data of workers;
(c) central input storing means for storing said inputs from users of said time and attendance system.
